(19) United States
(12) Patent Application Publication
(10) Pub. No.: US 2025/0063120 A1
(43) Pub. Date: Feb. 20, 2025

(54) MACHINE LEARNING TECHNIQUES FOR INTENT-BASED ROUTING OF CALLER COMMUNICATIONS

(71) Applicant: Wayfair LLC, Boston, MA (US)

(72) Inventors: Duncan Renfrow-Symon, Arlington, MA (US); Roger Bock, Manchester-by-the-Sea, MA (US); Chandrasekhar Venkata Ganduri, North Grafton, MA (US); Ashequl Qadir, Melrose, MA (US); Sunpreet Singh, Needham, MA (US); Michael Solway, Annandale, NJ (US); Bradley Mensing West, Boston, MA (US); Graham Robert Ganssle, Austin, TX (US); Sandeep Kandekar, Hopkinton, MA (US); Anh Do, Stoneham, MA (US); Harsimranjit Singh, Quincy, MA (US); Sanjeev Singh Sahni, Spring, TX (US); Vaidyanathan Raghavan, Newton, MA (US); Stephen Gershman, Arlington, MA (US); Susan Golbe, Cambridge, MA (US)

(21) Appl. No.: 18/804,897

(22) Filed: Aug. 14, 2024

Related U.S. Application Data
(60) Provisional application No. 63/519,705, filed on Aug. 15, 2023.

(51) Int. Cl. H04M 3/523; G10L 15/16; G10L 15/30; H04L 51/02; H04M 3/51

(52) U.S. Cl. CPC H04M 3/5233; G10L 15/16; G10L 15/30; H04L 51/02; H04M 3/5166; H04M 2201/40; H04M 2203/402

(57) ABSTRACT

Techniques for assigning agents to callers that have contacted a contact center by using a communication management system. The techniques include initiating a communication session between a caller and the communication management system, obtaining caller data by obtaining data from the caller in the communication session and/or obtaining data about the caller's historical behavior, identifying an intent of the caller by using the caller data and a trained machine learning model configured to predict intent of callers, identifying, from a plurality of agents, an agent to assign to the caller in the communication session by using the identified intent and an agent performance model configured to rank at least some of the plurality of agents based on a measure of their performance in communication sessions with callers having a same intent as the identified intent, and assigning the identified agent to the caller.

### RELATED APPLICATIONS

This application claims the benefit of priority under 35 U.S.C. § 119(e) to U.S. Provisional Patent Application Ser. No. 63/519,705, filed on Aug. 15, 2023, titled “Machine Learning Techniques for Intent-Based Routing of Caller Communications,” which is hereby incorporated by reference herein in its entirety.

### BACKGROUND

Retailers use contact centers to handle calls from customers relating to products sold by the retailers. Customer service representatives (also referred to as “agents”) employed by the contact centers interact with the customers to address their needs, concerns, and/or questions relating to the products. When a customer calls the contact center, the call is routed to the first available agent who then interacts with the customer. The agent may redirect the customer to another agent when the other agent can better assist the customer's needs.

### SUMMARY

Some embodiments provide for a method for assigning agents to callers that have contacted a contact center by using a communication management system for the contact center. The method comprises using at least one computer hardware processor to perform: initiating a communication session between a caller and the communication management system; obtaining caller data by obtaining data from the caller in the communication session and/or obtaining data about the caller's historical behavior; identifying an intent of the caller by using the caller data and a trained machine learning (ML) model configured to predict intent of callers; identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and assigning the identified agent to the caller.

Some embodiments provide for a system for assigning agents to callers that have contacted a contact center by using a communication management system for the contact center. The system comprises at least one computer hardware processor; and at least one non-transitory computer readable storage medium storing processor-executable instructions that, when executed by the at least one computer hardware processor, cause the at least one computer hardware processor to perform: initiating a communication session between a caller and the communication management system; obtaining caller data by obtaining data from the caller in the communication session and/or obtaining data about the caller's historical behavior; identifying an intent of the caller by using the caller data and a trained machine learning (ML) model configured to predict intent of callers; identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and assigning the identified agent to the caller.

Some embodiments provide for at least one non-transitory computer-readable storage medium storing processor-executable instructions that, when executed by at least one computer hardware processor, cause the at least one computer hardware processor to perform: initiating a communication session between a caller and a communication management system; obtaining caller data by obtaining data from the caller in the communication session and/or obtaining data about the caller's historical behavior; identifying an intent of the caller by using the caller data and a trained machine learning (ML) model configured to predict intent of callers; identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and assigning the identified agent to the caller.

### BRIEF DESCRIPTION OF DRAWINGS

Various aspects and embodiments will be described herein with reference to the following figures. It should be appreciated that the figures are not necessarily drawn to scale. Items appearing in multiple figures are indicated by the same or similar reference number in all the figures in which they appear.

FIG. 1 is a block diagram of a prior art system for routing voice calls from customers to one or more agents.

FIGS. 2A-2B are block diagrams of an example system in which some embodiments of the technology described herein operate.

FIG. 3 illustrates a diagram of an example flow of acts performed by the system shown in FIGS. 2A-2B, according to some embodiments of the technology described herein.

FIG. 4A illustrates an example portion of an agent performance model including information associated with an agent, according to some embodiments of the technology described herein.

FIG. 4B-4C illustrate example portions of an agent performance model including information associated with multiple agents, according to some embodiments of the technology described herein.

FIG. 5 is a flowchart of an example process for assigning agents to callers that have contacted a contact center using the system shown in FIGS. 2A-2B, according to some embodiments of the technology described herein.

FIG. 6 is block diagram illustrating an example implementation of the system shown in FIGS. 2A-2B, where a communication session between a caller and the system is initiated by receiving a voice call from the caller, according to some embodiments of the technology described herein.

FIG. 7 is block diagram illustrating an example implementation of the system shown in FIGS. 2A-2B, where a communication session between a caller and the system is initiated by initiating a chat between a caller and the system, according to some embodiments of the technology described herein.

FIG. 8 is an example simulator framework used for assessing performance indicator lifts when using the system shown in FIGS. 2A-2B for handling caller communication sessions, according to some embodiments of the technology described herein.

FIG. 9 illustrates an example Bayesian shrinkage model used in an example implementation of the system shown in FIGS. 2A-2B, according to some embodiments of the technology described herein.

FIG. 10 is a block diagram illustrating an example implementation of the agent identification module 224 of the system shown in FIGS. 2A-2B, according to some embodiments of the technology described herein.

FIG. 11 is a diagram illustrating example machine learning models used for a machine learning agent performance model (ML-APM) approach, according to some embodiments of the technology described herein.

FIG. 12 is a block diagram of an example computer system, according to some embodiments of the technology described herein

### DETAILED DESCRIPTION

A retailer's contact center typically receives calls from customers regarding products sold or offered by the retailer. For example, a customer may call the contact center to obtain shipping or delivery information regarding a purchased product. As another example, a customer may call the contact center to indicate dissatisfaction with a purchased product and obtain a refund or replacement for the purchased product. As yet another example, a customer may call the contact center to request assembly instructions for a purchased product. Customers may call the contact center for other reasons not necessarily related to a purchased product, such as, account or billing questions, address change requests, and questions relating to a product the customer wishes to buy.

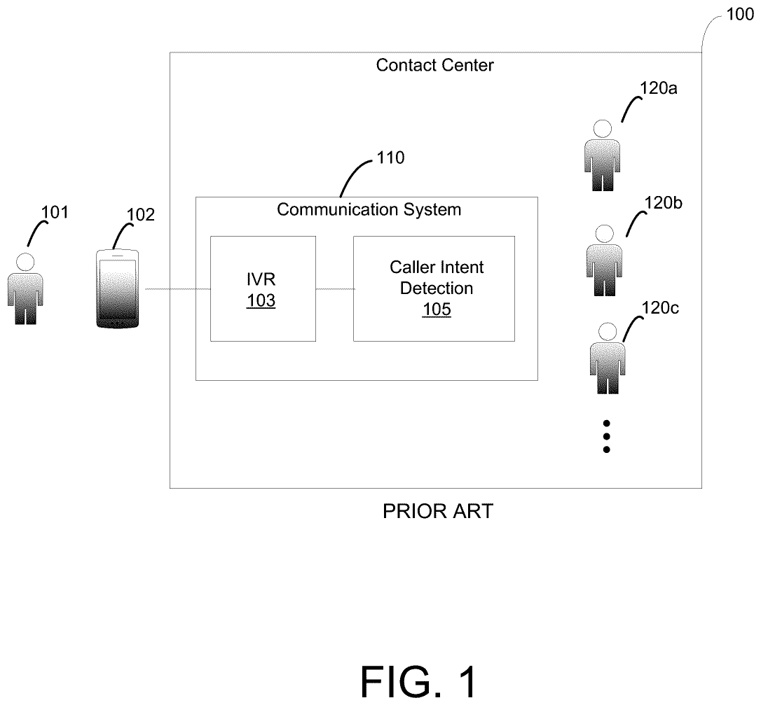

A contact center operates with the help of communication systems that route customers' calls to agents and support communication between the customers and the agents. Some conventional communication systems employed at contact centers assign first-available agents to a customer. Other conventional communication systems employed at contact centers attempt to determine the reason for a customer's call by asking the customer questions and route the customer's call accordingly. An example of such a conventional communication system 110 is shown in FIG. 1. The communication system 110 is employed at a contact center 100 and includes an interactive voice response (IVR) system 103 and a caller intent detection system 105. The communication system 110 operates to connect customers, such as customer 101 calling using their smartphone 102 to one of multiple agents 120a, 120b, 120c, etc.

In this example of a conventional communication system, IVR 103 is an automated interactive voice response system that answers incoming calls from customers and solicits customers' responses to a number of questions. Caller intent detection system 105 uses the customers' responses to the questions to route the customers to an available agent, such as one of the agents 120a, 120b, and 120c. Caller intent detection system 105 determines, from the customers' responses to the questions, a reason for a call and routes the call to an agent from the appropriate department. For example, in response to determining that a customer is calling about a billing question, the caller intent detection system routes the customer to an agent in the billing department. As another example, in response to determining that a customer is calling about a shipping question, the caller intent detection system routes the customer to an agent in the shipping department. This conventional department-based routing approach requires creation of different specialized departments and that agents be segmented into or belong to these different specialized departments.

The inventors have recognized that conventional systems for routing customer calls to agents can be improved upon in a number of ways. First, the inventors have recognized that conventional systems for routing customer calls are burdensome on the customer because they collect a lot of information from the customer in order to route their call. Customers may need to answer multiple questions, enter various information (e.g., by using their Dialpad), and navigate through multiple menus of options. This is not only tedious and time-consuming process, but one that requires additional communications between the customer's device and the system for routing customer calls, which takes valuable communication system and network resources. Additionally, the customer cannot always describe the reason for their call or select an option that accurately captures their intent, which leads to incorrect intent identification even with simple binary choices (e.g., sales versus service). Moreover, although conventional systems for routing customer calls collect some information about a customer from their responses (e.g., a customer's account number, phone number, order information, etc.), these systems are not designed to use and do not use the customer's historical information (e.g., previous orders, browsing history, and/or other information) for determining the intent for the call. However, as the inventors recognized, using such information can improve the accuracy of determining the customer's intent in contacting the contact center and can further reduce the amount of information that needs to be collected from the customer during a call.

Second, the inventors have recognized that conventional system for routing customer calls do not assign the best agents for handling the calls because these conventional systems do not adequately account for capability, experience, and/or other characteristics of agents that can be assigned to interact with the customers. For example, a customer may call regarding a complaint about a purchased product. A conventional call routing system would route the call to the first available agent in the returns department (after asking the caller multiple questions about why they are calling). Some agents in the returns department may be adept at handling return requests whereas other agents may be adept at handling product replacements and shipping of replacement parts. If the customer wishes to request a refund but is routed to an agent who has not previously handled many refund requests or has not handled previous refund requests efficiently or is otherwise adept at handling product replacements rather than refund requests, the customer's experience can be negatively impacted.

Third, the inventors have recognized that the conventional department-based routing approach (1) can lead to staffing inefficiencies as it is difficult to accurately staff each specialized department given the variance of contact volume to that department, and (2) does not allow for cross-training and agent up-skilling.

The inventors have developed an improved communication management system for routing customer calls to agents. The communication management system developed by the inventors addresses the above-described drawbacks of conventional systems for routing customer calls. To this end, the communication management system developed by the inventors includes: (1) machine learning technology for accurately determining the intent of a caller without requiring extensive/expensive caller input; and (2) an agent performance model that identifies the most suitable agent to assign to the caller based on the caller's identified intent and on historical performance of agents when interacting with callers having that identified intent. Assigning the customer to a specific agent who is adept at handling calls with the identified intent increases the chances that the customer will be satisfied as a result of the interaction with the agent.

As used herein, a “caller” refers to any person that is participating in a communication session with a communication management system. The communication session may be a voice call, a chat session, or any other suitable type of communication session supported by the communication management system. Thus, a caller may communicate with the communication management system using a voice call, a chat (e.g., via an interface supported by an Internet browser or any other suitable software application program), or in any other suitable way.

In some embodiments, a caller may interact with the communication management system via a voice call. The caller may make the voice call using any suitable device(s), technologies, and communication protocols including, but not limited to, telephone, mobile phone (e.g., smartphone), public Voice over IP (VoIP), Voice over Long Term Evolution (VoLTE), public switched telephone network (PSTN).

In some embodiments, a caller may interact with the communication management system via a chat. To that end, the caller may provide text input via an interface of the software program (e.g., Internet browser, an app installed on a caller's device, or any other suitable type of software application program) and may receive textual output via the interface. However, in addition to or instead of text, the caller and communication management system may provide other types of content to one another, such as image (e.g., an image of a product, such as a broken or defective product, an image of a return label, etc.), video (e.g., a video of a product, such as a broken or defective product), and/or sound (e.g., a recording of the caller's voice), as chat based communications are not limited to solely textual communications.

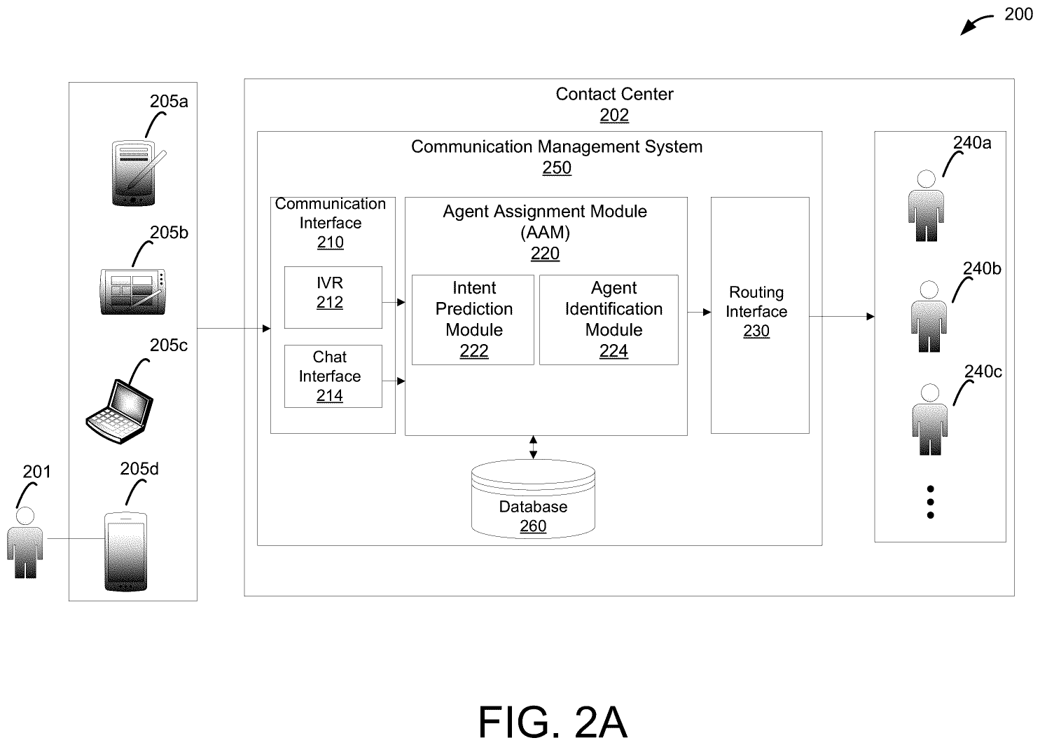

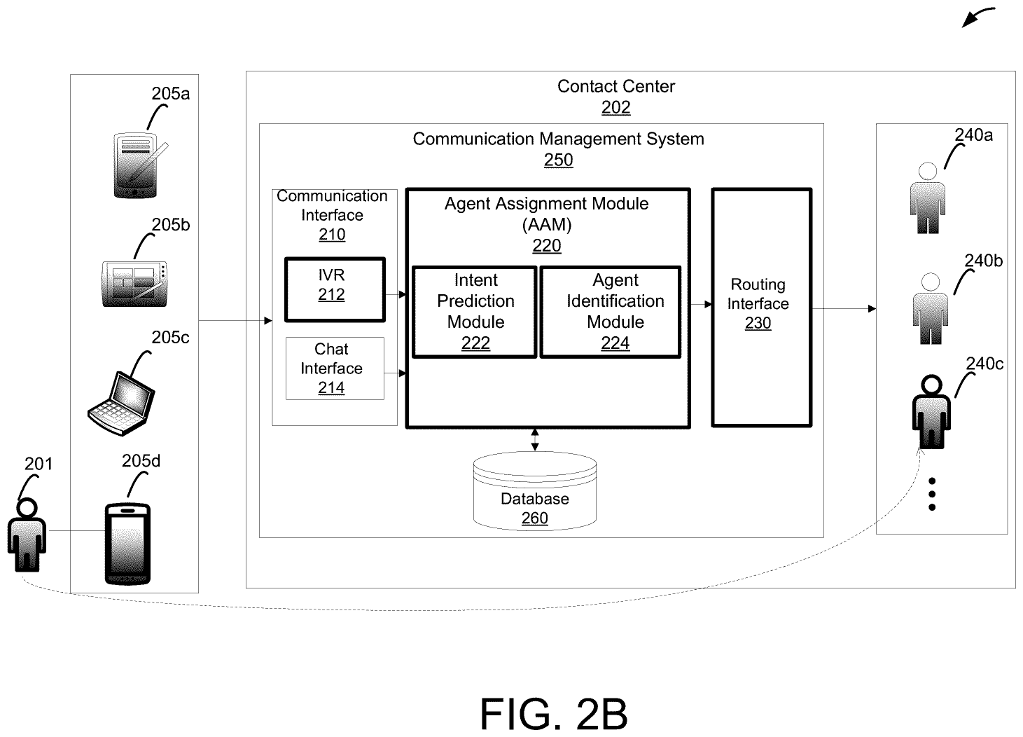

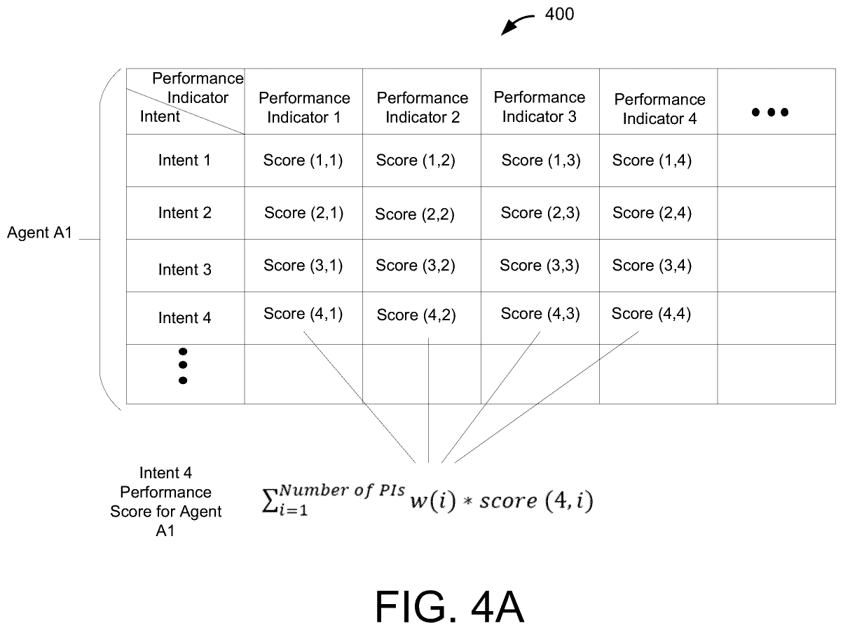

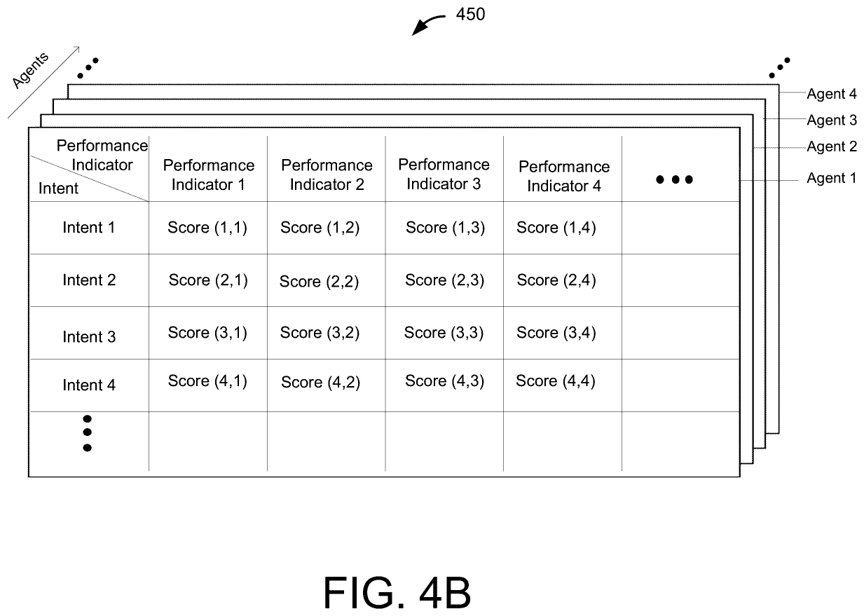

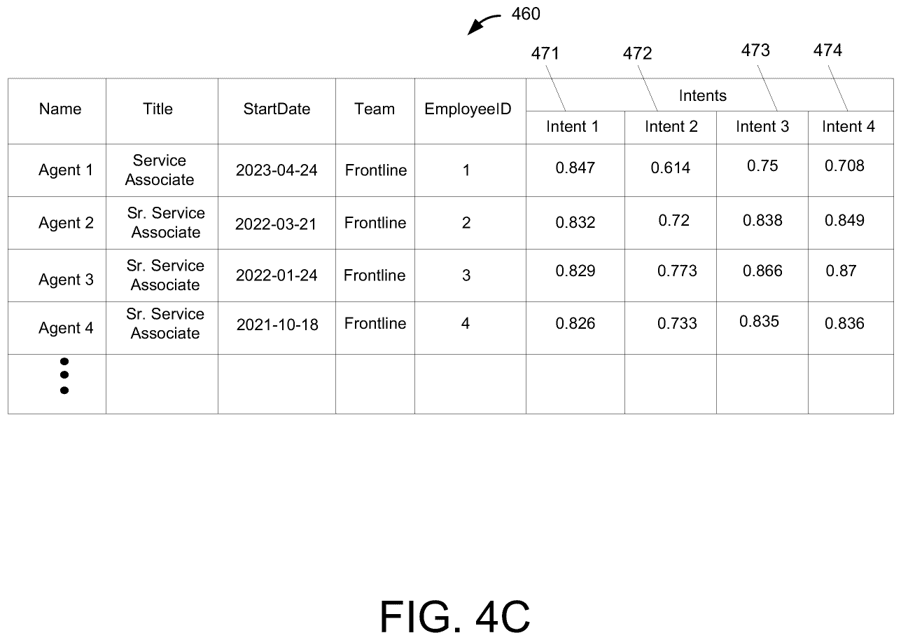

Accordingly, some embodiments provide for a method for assigning agents to callers that have contacted a contact center by using a communication management system (e.g., system 250 in FIGS. 2A-2B) for the contact center, the method comprising: (A) initiating a communication session between a caller and the communication management system (e.g., in response to receiving a voice call or a chat message from a caller shown in FIG. 2A); (B) obtaining caller data by obtaining data from the caller in the communication session (e.g., via the IVR 212 or chat interface 214) and/or obtaining data (e.g., from database 260) about the caller's historical behavior (e.g., information about one or more previously purchased products, information about one or more prior calls from the caller to the contact center, etc.); (C) identifying an intent of the caller by using the caller data and a trained machine learning (ML) model configured to predict intent of callers (e.g., the intent may be any one of the intents listed in Table 1, for example); (D) identifying, from a plurality of agents, an agent to assign to the caller in the communication session by using the identified intent of the caller and an agent performance model (APM) (shown in FIGS. 4A-4C, for example) configured to rank at least some of the plurality of agents based on a measure of their performance in communication sessions with callers having a same intent as the intent of the caller; and (E) assigning the identified agent to the caller.

In some embodiments, initiating the communication session between the caller and the communication management system comprises receiving a voice call from the caller by the communication management system. For example, the communication management system may include an interactive voice response (IVR) system to receive the voice call and the communication session may be initiated, at least in part, by using the IVR system.

In some embodiments, initiating the communication session between the caller and the communication management system comprises initiating a chat between the caller and the communication management system. In some embodiments, the chat can involve exchange of text, image, video and/or any other type of data that may be communicated using a chat. In some embodiments, the communication session may be initiated, at least in part, by using a virtual assistant interacting with the caller via a software application (e.g., an Internet browser, an app running on the caller's device such as, for example, an app for the retailer).

In some embodiments, obtaining the caller data comprises obtaining one or more statements (e.g., statements made by voice or provided via the chat) from the caller in the communication session. The trained ML model may be configured to predict intent of callers from statements provided by callers. In some embodiments, identifying the intent of the caller comprises processing the caller data (containing the one or more statements) using the trained ML model to obtain output indicating one or more candidate intents and associated one or more scores. In some such embodiments, the trained ML model may be a trained language model comprising a trained neural network having a transformer architecture, though it should be appreciated that one or more other types of neural network architectures may be used in other embodiments. The trained ML model may comprise multiple parameters (e.g., between 100 and 500 million parameters), and processing the caller data using the trained ML model may include calculating the output indicating the one or more candidate intents and associated one or more scores using the caller data and values of the multiple parameters.

In some embodiments, the trained ML model may comprise a Bidirectional Transformers (BERT) model described in Devlin et. al., “BERT: Pre-training of Deep Bidirectional Transformers for Language Understanding,” Computation and Language, arXiv:1810.04805, May 2019, which is incorporated by reference herein in its entirety. In some embodiments, the trained ML model may comprise a RoBERTa model described in Liu et al., “A Robustly Optimized BERT Pretraining Approach,” Computation and Language, arXiv:1907.11692, July 2019, which is incorporated by reference herein in their entirety. In some embodiments, a trained ML model that is a variation of the BERT and/or RoBERTa models may be used, as aspects of the technology described herein are not limited in this respect.

In some embodiments, obtaining the caller data comprises obtaining data about the caller's historical behavior. This data may include, but not be limited to, information about the caller's previous orders (e.g., number, type, and pricing of orders placed), information about the caller's browsing behavior on the retailer's online shopping platform (e.g., recent products viewed by the caller, recent interactions, such as clicks, with the graphical user interface of the online shopping platform (e.g., website interactions, etc.)), information about the caller's purchasing behavior (e.g., number of items purchased in the last year and their prices), information about the caller's contact history (e.g., a number of times the caller contacted the contact center in the past year), information about product incidents (e.g., a number of times an interaction with the caller lead to a product incident report), and fulfillment details (e.g., details on inventory management, packing, shipping, delivery, and returns of purchased items). The trained ML model may be configured to predict intent of callers using features (e.g., one, some or all of the features listed in Table 2) derived from data about callers' historical behavior. In some embodiments, identifying the intent of the caller comprises processing the caller data using the trained ML model to obtain output indicating one or more candidate intents and associated one or more scores. In some such embodiments, the trained ML model may be a decision tree model, a random forest model, a neural network model, or any other suitable type of machine learning model.

In some embodiments, the trained ML model may include an ensemble of machine learning models of any suitable type (the machine learning models part of the ensemble may be termed “weak learners”). For example, the ML model may include an ensemble of decision tree models (e.g., decision tree classifiers). For example, in some embodiments, the trained ML model may comprise a gradient-boosted decision tree model. The gradient-boosted decision tree model may be an ensemble of multiple decision trees (e.g., between 100-1000 decision trees, between 500-1000 decision trees, between 250-750 decision trees, or any other suitable range within these ranges). The prediction (e.g., classification) generated by the gradient-boosted decision tree model is formed based on the predictions generated by the multiple decision trees part of the ensemble. The ensemble may be trained using an iterative optimization technique involving calculation of gradients of a loss function (hence the name “gradient” boosting). Any suitable supervised training algorithm may be applied to train a gradient-boosted decision tree model including, for example, any of the algorithms described in Hastie, T.; Tibshirani, R.; Friedman, J. H. (2009). “10. Boosting and Additive Trees”. The Elements of Statistical Learning (2nd ed.). New York: Springer. pp. 337-384. In some embodiments, the gradient-boosted decision tree model may be implemented using any suitable publicly available gradient boosting framework such as XGBoost (e.g., as described, for example, in Chen, T., & Guestrin, C. (2016). XGBoost: A Scalable Tree Boosting System. In Proceedings of the 22nd ACM SIGKDD International Conference on Knowledge Discovery and Data Mining (pp. 785-794). New York, NY, USA: ACM.). The XGBoost software may be obtained from http://xgboost.ai, for example). Another example framework that may be employed is LightGBM (e.g., as described, for example, in Ke, G., Meng, Q., Finley, T., Wang, T., Chen, W., Ma, W., . . . Liu, T.-Y. (2017). Lightgbm: A highly efficient gradient boosting decision tree. Advances in Neural Information Processing Systems, 30, 3146-3154.). The LightGBM software may be obtained from https://lightgbm.readthedocs.io/, for example). Yet another example framework that may be employed is CatBoost (e.g., as described, for example, in Prokhorenkova et al., “CatBoost: unbiased boosting with categorical features,” Machine Learning, arXiv:1706.09516, January 2019 and Dorogush et al., “CatBoost: gradient boosting with categorical features support,” Machine Learning, arXiv:1810.11363, October 2018). These articles are incorporated by reference herein in their entirety.

In some embodiments, a neural network classifier may be used. The neural network classifier may be trained using any suitable neural network optimization software. The optimization software may be configured to perform neural network training by gradient descent, stochastic gradient descent, or in any other suitable way. In some embodiments, the Adam optimizer (Kingma, D. and Ba, J. (2015) Adam: A Method for Stochastic Optimization. Proceedings of the 3rd International Conference on Learning Representations (ICLR 2015)) may be used. This article is incorporated by reference herein in its entirety.

In some embodiments, the agent performance model (APM) indicates, for each of the plurality of agents and with respect to communication sessions with callers having the same intent as the intent of the caller, a plurality of performance scores for a corresponding plurality of performance indicators (e.g., one, some or all of the performance indicators listed in Table 3). Performance indicators may also be referred to as key performance indicators (KPIs).

In some embodiments, identifying the agent to assign to the caller using the identified intent of the caller and the APM, comprises determining, for each particular agent of the at least some of the plurality of agents, a measure of performance of the particular agent using weighted combination (e.g., as shown in FIG. 4A) of the plurality of performance scores of the particular agent, thereby obtaining a plurality of measures of performance, and ranking the at least some of the plurality of agents using the plurality of measures of performance.

In some embodiments, the plurality of performance indicators comprises one or more (e.g., one, some, or all of the) performance indicators listed in Table 3. In some embodiments, the plurality of performance indicators comprises one or more performance indicators selected from the group consisting of a customer satisfaction score, a first contact resolution indicator, a low-cost resolution indicator, an average handling time, a compliance indicator relating to lost in transit item, and a compliance indicator relating to return shipping fees.

In some embodiments, various parameters of the agent performance model may be determined prior to using the agent performance model to assign agents to callers. For example, prior to identifying the agent to assign to the caller using the identified intent of the caller and the APM, weights to use as part of the APM may be determined. The weights may be used when determining the measure of performance of the particular agent using the weighted combination of the plurality of performance scores of the particular agent.

As another example, the APM may include various agent performance scores, which may be determined prior to using the APM to assign agents to callers. For example, in some embodiments, the method involves determining, for each of the plurality of agents and for each of a plurality of intents, the plurality of performance scores for the corresponding plurality of performance indicators.

In some embodiments, the plurality of agents includes a first agent, the plurality of intents includes a first intent, the plurality of performance indicators includes a first performance indicator, and determining, for each of the plurality of agents and for each of a plurality of intents, the plurality of performance scores for the corresponding plurality of performance indicators comprises determining a first performance score for the first performance indicator of the first agent handling communication sessions with callers having the first intent at least in part by: determining a number of communication sessions, handled by the first agent, with callers having the first intent, when the number of communication sessions is greater than a threshold number of communication sessions with callers having the first intent, determining the first performance score based on performance indicator data about the first agent's communication sessions with callers having the first intent, and when it is determined that the first agent has not handled the threshold number of communication sessions with callers having the first intent, determining the first performance score based on: (1) performance indicator data about the first agent's communication sessions with callers having the first intent; and (2) performance indicator data about the communication sessions between one or more other agents with callers having the first intent.

In some embodiments, determining the first performance score based on: (1) performance indicator data about the first agent's communication sessions with callers having the first intent; and (2) performance indicator data about the communication sessions between one or more other agents with callers having the first intent is performed using a shrinkage estimator (e.g., using Bayesian shrinkage). Aspects of shrinkage estimators are described in Copas, J. B. (1983). “Regression, Prediction and Shrinkage”. Journal of the Royal Statistical Society, Series B. 45 (3): 311-354, which is incorporated by reference herein in its entirety.

In some embodiments, the agent performance model comprises a set of trained machine learning (ML) models, wherein each trained ML model in the set is trained to predict, for each of the plurality of agents and with respect to communication sessions with callers having the same intent as the intent of the caller, a performance score for a corresponding performance indicator. In some embodiments, identifying the agent to assign to the caller using the identified intent of the caller and the APM comprises using the set of trained ML models to determine a measure of performance for each of the at least some of the plurality of agents to obtain a set of measures of performance, and ranking the at least some of the plurality of agents using the plurality of measures of performance.

In some embodiments, the set of trained ML models to determine a measure of performance for each of the at least some of the plurality of agents comprises for each particular agent of the at least some of the plurality of agents, determining a plurality of performance scores for the particular agent using the set of trained ML models, and determining a measure of performance for the particular agent using the plurality of performance scores.

In some embodiments, the agent performance model further comprises an ensemble ML model, and wherein determining the measure of performance for the particular agent using the plurality of performance scores comprises processing the plurality of performance scores using the ensemble ML model to determine the measure of performance.

In some embodiments, the set of trained ML models comprises a gradient boosted decision tree model. In some embodiments, each of the ML models in the set of trained ML models is a gradient boosted decision tree model. In some embodiments, the ensemble ML model comprises a gradient boosted decision tree model.

It should be appreciated that the embodiments described herein may be implemented in any numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

Some embodiments described herein address all the above-described issues that the inventors have recognized with conventional systems for routing callers to agents in a contact center. However, it should be appreciated that not every embodiment described herein addresses every one of these issues. It should also be appreciated that embodiments of the technology described herein may be used for purposes other than addressing the above discussed issues of conventional techniques.

FIG. 2A is a block diagram of an example system 200 in which some embodiments of the technology described herein may be implemented. System 200 may include client devices 205a, 205b, 205c, 205d (referred to herein as “205”) and a contact center 202 including a communication management system 250 and agents 240a, 240b, 240c (referred to herein as “240”). The client device 205 may include an interface of a software program (e.g., Internet browser or any other suitable type of software application program) installed thereon. The client device 205 may be an electronic portable device, such as a smart phone or a tablet PC. In other examples, the client device 205 may be a computer (e.g., a desktop computer, a tablet PC, a terminal device). In yet another example, the client device 205 may be a telephone or any suitable device that may be used by a caller to interact with the communication management system 250.

In some embodiments, communication management system 250 may initiate a communication session between a caller 201 and the communication management system 250. For example, the communication session may be initiated in response to receiving a communication from the caller (e.g., receiving a voice call, receiving a message via chat). As another example, the communication session may be initiated in response to an earlier communication (e.g., an earlier call or chat message) requesting that the communication management system contact the caller at a later time (e.g., at a desired time when the caller is free, at a time when an agent is available to speak or chat with the caller, etc.). As yet another example, the communication management system may proactively initiate a communication session with a caller (i.e., not in response to a caller's action requesting such a communication session). For example, the communication system may initiate a call with a customer to provide them with information about an order they placed (e.g., regarding shipping, delivery, delay, billing, etc.).

In some embodiments, communication management system 250 may include a communication interface 210, an agent assignment module (AAM) 220, a routing interface 230, and a database 260. The communication interface 210 may implement various technologies that facilitate callers' interaction with the communication management system 250. For example, the communication interface 210 may include an interactive voice response (IVR) system 212 for facilitating voice calls from the caller 201. In this example, initiating a communication session between the caller 201 and the communication management system 250 may be performed by the IVR system 212. As another example, the communication interface 210 may include a chat interface 214 facilitating textual, image or video input by the caller 201. In this example, initiating a communication session between the caller 201 and the communication management system 250 may be performed by the chat interface 214. It will be appreciated that any suitable interface may be provided as part of the communication interface 210 to facilitate interaction between the caller 201 and the communication management system 250 as aspects of the disclosure are not limited in this respect. For example, the communication interface 210 may include a virtual assistant for facilitating interaction between the caller 201 and the communication management system 250, where initiating a communication session between the caller 201 and the communication management system 250 may be performed by the virtual assistant interacting with the caller 201 via a software application.

In some embodiments, AAM 220 may include an intent prediction module 222 and an agent identification module 224. The intent prediction module 222 may obtain caller data from the communication interface 210 and/or database 260 and identify an intent of the caller using the caller data and a trained ML model configured to predict intent of callers. In some embodiments, the intent prediction module 222 may obtain caller data by obtaining data from the caller 201 in the communication session and/or obtaining data about the caller's historical behavior from the database 260.

In some embodiments, caller data may be obtained from the caller 201 in the communication session initiated between the caller 201 and the communication management system 250. The caller data may include caller information (e.g., account information (e.g., account id, account status, etc.), phone number, email address, etc.), order information (e.g., order id, brief description of ordered item, etc.), statement(s) provided by the caller, and/or other information.

In some embodiments, obtaining the caller data may include obtaining statement(s) from the caller 201 in the communication session. The statement(s) may include textual input obtained via the chat interface 214 or one or more utterances obtained via interaction with a voice interface, such as a virtual assistant. In some embodiments, the intent prediction module 222 may include a first trained ML model that is configured to predict intent of callers from statements provided by callers. In some embodiments, the first trained ML model may identify the intent of the caller by processing the caller data using the first trained ML model to obtain output indicating one or more candidate intents and associated one or more scores. For example, the caller 201 may provide textual input “Wrong product received. Order #12345.” or say, “I received a wrong product for order #12345. I ordered a black cup but received a blue one.” These statements may be processed using the first trained ML model to identify an intent of the caller. The first trained ML model may generate an output indicating one or more candidate intents and associated one or more scores. The one or more candidate intents may include intents selected from the group of intents listed in Table 1. For example, when processing the textual input above, the output of the first trained ML model may indicate multiple candidate intents “Wrong Product,” “Wrong Size Received,” “Wrong Color Received,” and “Wrong Item Received,” along with a score for each intent. As another example, when processing the utterance above, the output of the first trained ML model may indicate one candidate intent “Wrong Color Received” and an associated score.

TABLE 1

| | | Intent Name | |
|---|---|---|---|
| | | (Sub-categories | |
| | | of Intent in first | |
| Intent Name | Intent Description | column) | Intent Description |
| Address Change | Customer needs to change the | Address Change | Customer needs to change or edit |
| | address. The request can | | the address. The request can happen |
| | happen before at any point in | | before at any point in the order (pre- |
| | the order (pre-shipment, in | | shipment, in transit or after delivery) |
| | transit or after delivery) | | |
| Assembly | Customer has questions on | Missing Assembly | Customer is requesting Assembly |
| Instructions | how to assemble the product. | Instructions | Instructions |
| | This includes asking for | | |
| | assembly instructions to be | | |
| | sent | | |
| | | Question on How | Customer has question on how to |
| | | to Assemble | assemble the item. Does not include |
| | | | situations where the product is |
| | | | defective and cannot be assembled |
| | | | (e.g., holes don't align with each |
| | | | other) |
| Assembly | Customer has questions | Reschedule | Customer wants to reschedule |
| Professional | regarding assembly services | Assembly | professional services appointment, |
| Services | provided by a professional. | (Professional) | usually due to delivery date change |
| | This can include | Services | and/or customer availability |
| | rescheduling/refund related | | |
| | questions for professional | | |
| | assembly services. Handy is | | |
| | the name of a provider of home | | |
| | assembly services. | | |
| | | Question about | Customer has a |
| | | Assembly | question on how |
| | | (Professional) | the home services |
| | | Services | (professional |
| | | | assembly) |
| | | | process works. |
| | | | Questions may |
| | | | include what is/is |
| | | | not included in the |
| | | | service (such as |
| | | | disposal of boxes) |
| | | | and how the |
| | | | handoff between |
| | | | assembly and |
| | | | delivery works. |
| | | Canceling | Customer needs to cancel |
| | | Assembly | professional assembly services. |
| | | (Professional) | |
| | | Services | |
| | | Refund/Discount | Customer wants to request a refund |
| | | Request for | for professional assembly services |
| | | Assembly | because services were not performed |
| | | (Professional) | or were not satisfactory |
| | | Services | |
| | | Question about | Customer wants to confirm |
| | | Assembly | professional assembly services are in |
| | | (Professional) | place for a replacement item. The |
| | | Services for a | replacement item is replacing an |
| | | Replacement | original item that was supposed to |
| | | Order | have assembly services. |
| | | Add Assembly | Customer wants to add professional |
| | | Services | assembly services to an existing |
| | | | order. |
| Cancellation | Customer is trying to cancel an | Cancellation Setup | Customer is trying to cancel an item. |
| | item. This can include | | There is no indication of previous |
| | situations where the item has | | attempts to cancel. This does NOT |
| | not been shipped, is in transit | | include attempts to cancel a |
| | or has already been delivered. | | replacement item/part that is being |
| | This does NOT include | | sent to the customer. |
| | situations when a customer | | |
| | wants to cancel a replacement | | |
| | part or item. | | |
| | | Cancellation | Customer tried to cancel previously |
| | | Failure | but the cancellation did not go |
| | | | through. The customer may be trying |
| | | | to cancel the item again or has a |
| | | | question on why it has not been |
| | | | cancelled. This does NOT include |
| | | | instances where customer is trying to |
| | | | return an item that has previously |
| | | | been cancelled |
| Charge Amount | Customer has a question | Charge Amount | Customer has a question regarding |
| Question | regarding the amount that they | Question | the amount that they were charged |
| | were charged for a product that | | for a product that was recently |
| | was recently purchased. This | | purchased. This does NOT include |
| | does NOT include questions | | questions about return shipping costs |
| | about return shipping costs or | | or refund processes/procedures |
| | refund processes/procedures. | | |
| Confirmation of | Customer wants to confirm that | Confirmation of | Customer wants to confirm that they |
| Purchase | they purchased the right item | Item | purchased the right item |
| | or that their billing/payment | | |
| | was processed successfully | | |
| | | Confirmation of | Customer wants to confirm that their |
| | | Billing | payment/billing information was |
| | | | processed successfully |
| Complaint | Customer wants to express | Complaint | Customer wants to express some |
| | some frustration but is not | | frustration but is not looking for |
| | looking for information/issue | | information/issue resolution |
| | resolution | | |
| Customer | Customer requests to change | Customer Contact | Customer requests to change the |
| Information | email, password, phone | Information | email, password, and/or phone |
| Change | number, payment and/or billing | Change | associated with their account. This |
| | address. This does NOT | | does NOT include changes to billing |
| | include changes to shipping | | address, billing information, or |
| | address | | shipping address for an existing |
| | | | order. |
| | | Billing Information | Customer is looking to update their |
| | | Change | billing address. |
| | | Close Account | Customer is requesting to close their |
| | | | account with retailer. |
| | | Edit Payment | Customer is looking to change or |
| | | Options | update their payment information. |
| | | Duplicate Charges | Customer wants to know why they |
| | | | see multiple charges on their credit |
| | | | card or bank statement or thinks |
| | | | they've been overcharged. |
| | | Outstanding | Customer wants to know what an |
| | | Balance | outstanding balance is and how to |
| | | | resolve it. |
| Customer | Customer wants to change | Customer | Customer wants change retailer's |
| Communication | their communications settings | Communication | communication preference (more |
| Preferences | with retailer (more emails/texts | Preferences | emails/texts or less emails/texts). |
| | or fewer emails/texts). Includes | | Includes subscribing and |
| | subscribing and unsubscribing | | unsubscribing from emails/texts |
| | from emails/texts. | | |
| Delivery | Customer wants to provide the | Delivery | Customer wants to provide the carrier |
| Instructions | carrier with instructions on | Instructions | with instructions on where to drop off |
| | where to drop off the item | | the item (specific location around a |
| | (specific location around a | | house/building) and/or what to do |
| | house/building) and/or what to | | when they arrive with their item (ring |
| | do when they arrive with their | | doorbell, etc.) |
| | item (ring doorbell, etc.) | | |
| Delivery Service | Customer is requesting to | Delivery Service | Customer is requesting to upgrade |
| Level Upgrade | upgrade their delivery to in | Level Upgrade | their delivery to in house or in room |
| | house or in room drop-off | | drop-off |
| Damage/Defect | Customer indicated that there | Damage | Customer indicated that the item they |
| | is damage with the | | received is damaged. This includes |
| | item/packaging. Also, customer | | requests to get refund and/or return |
| | can note that the item is not | | the item because of damage |
| | functioning properly due to | | |
| | defect. Customer can also | | |
| | want to confirm that a report of | | |
| | a damaged or defective item | | |
| | has been successfully | | |
| | submitted and inquire about | | |
| | how to dispose of an item. | | |
| | | Defect | Customer reports that the item is not |
| | | | functioning properly/ is defective. |
| | | | Customer may report that they were |
| | | | unable to assemble an item because |
| | | | of a defect. This includes requests to |
| | | | get refund and/or return the item |
| | | | because item is not working properly |
| | | Damage/Defect | Customer wants to confirm that a |
| | | Confirmation | request to solve a damaged or |
| | | | defective item has been successfully |
| | | | submitted |
| | | Replacement | Customer is looking to cancel a |
| | | Cancellation | replacement item or part. Common |
| | | (Damage/Defect) | reasons for cancellation: it is taking |
| | | | too long to get the replacement, |
| | | | customer wants a refund instead of |
| | | | the replacement, or customer is OK |
| | | | with keeping item with a discount |
| | | | instead of getting a replacement |
| | | Replacement | Customer is looking to get detail on |
| | | Questions | timing or logistics of replacing an item |
| | | | or part. Questions include clarification |
| | | | on which item/part is being sent to |
| | | | the customer, details on the color or |
| | | | specifications of the replacement |
| | | | item/part being sent, details on the |
| | | | shipping process of replacement |
| | | | items/parts. Does not include |
| | | | requests about whether a customer is |
| | | | eligible for a replacement or how to |
| | | | get started ordering a replacement. |
| | | Disposition of | Customer is asking how to dispose of |
| | | Damaged/Defective | an item. This follows a DnD or a |
| | | Item | Wrong Product report. |
| Fraud | Customer reports they did not | Fraud | Customer reports they did not make |
| | make a purchase. Includes | | a purchase. Includes claims that |
| | claims that account is | | account is compromised. Does NOT |
| | compromised. Does NOT | | include cases where customer |
| | include cases where customer | | receives wrong orders, products or |
| | receives wrong orders, | | quantities |
| | products or quantities | | |
| Ask for an agent | Generic requests to speak with | Ask for an agent | Generic requests to speak with an |
| | an agent customer service (i.e., | | agent customer service (i.e., ″Please |
| | ″Please transfer me to a | | transfer me to a customer service |
| | customer service | | representative″) |
| | representative″) | | |
| | | Business Hours | Customer is trying to contact the call |
| | | | center and wants to know if they are |
| | | | ″open″ and details of the contact |
| | | | options (ex: phone number, email |
| | | | address, initiate chat/SMS). |
| Gift Question | Customer has a question on | Gift Question | Customer has a question on logistics |
| | logistics for a purchase that is | | for a purchase that is a gift |
| | a gift | | |
| Gift Card | Customer has questions | Gift Card | Customer has questions regarding |
| | regarding gift card policies, | | gift card policies, delivery, return or |
| | delivery, return or refund of the | | refund of the gift card |
| | gift card | | |
| Happy Customer | Customer is happy and wants | Happy Customer | Customer is happy and wants to |
| | to express gratitude for the | | express gratitude for the Wayfair |
| | Wayfair experience | | experience |
| Missed Service | Customer paid extra for | Missed Service | Customer paid extra for premium |
| Upgrade | premium delivery (inside home | Upgrade | delivery (inside home or inside room) |
| | or inside room) option or | | option or expedited delivery but this |
| | expedited delivery but this | | service was not provided. Customer |
| | service was not provided. | | may ask for a refund for the missed |
| | Customer may ask for a refund | | service. |
| | for the missed service. | | |
| NOT AN | This field is reserved for | NOT AN INTENT | This field is reserved for gibberish or |
| INTENT | gibberish or wrong messages. | | wrong messages. It also covers |
| | It also covers customer | | customer statements that are |
| | statements that are unrelated | | unrelated to their orders or the |
| | to their orders or the retailer | | retailer (i.e., ″My mom is good″). Do |
| | (i.e., ″My mom is good″). Do | | not use this intent if the customer is |
| | not use this intent if the | | inquiring about anything related to |
| | customer is inquiring about | | the retailer |
| | anything related to the retailer | | |
| Not Received | Customer claims that an item | Item Not Received | Customer indicated they did not |
| | that should have been | | receive any of the item. Customer |
| | delivered was not. Includes | | may reference receiving a delivery |
| | situations where there was a | | notification but not seeing an item. |
| | delivery SMS/Email, package | | This does not include instances |
| | is running late (no scan), only | | where the customer specifies that the |
| | part of the item was delivered, | | item was shipped to the wrong |
| | or item and lower quantity of | | address. |
| | the item was delivered | | |
| | | Order Partially | Customer received some of the order |
| | | Delivered | but mentions that they are missing |
| | | | other items from their order. This |
| | | | does NOT include situations where |
| | | | the customer is missing parts or |
| | | | components of the same item. |
| | | Missing Parts | Customers report that they are |
| | | | missing parts of an item. This can be |
| | | | missing parts due to multiple boxes |
| | | | arriving on different dates or because |
| | | | parts are missing/hidden for an order |
| | | | they received. |
| | | Replacement | Customer wants to cancel a |
| | | Cancellation (Not | replacement because the original |
| | | Received) | item arrived |
| | | Smaller Quantity | Customer received a smaller amount |
| | | Delivered | of the item. (i.e., ordered 6 light bulbs |
| | | | but received 2). |
| Price Match | Customer is trying to adjust | Price Match | Customer is trying to adjust price |
| | price they paid for an item to a | | they paid for an item to a later (lower) |
| | later (lower) price on either our | | price on either our website or our |
| | website or our competitor's. | | competitor's. |
| Promo Code | Customer is looking to apply | Promo Code | Customer is looking to apply promo |
| | promo code after they placed | | code after they placed an order. This |
| | an order. This can also include | | can also include a question on how to |
| | a question on how to use a | | use a promo code on a new order |
| | promo code on a new order | | |
| Received Not | Customer has placed an order | Received Not | Customer has placed an order with |
| Ordered Item(s) | with us but received an extra | Ordered Item (Not | us but received an extra item that |
| | item that they did not order. | Fraud) | they did not order. This can be a |
| | This can be a different item or | | different item or a higher quantity of |
| | a higher quantity of the item | | the item they ordered (i.e., ordered 2 |
| | they ordered (i.e., ordered 2 | | chairs but received 3 chairs). This |
| | chairs but received 3 chairs). | | does NOT include instances where |
| | This does NOT include | | customers received the wrong |
| | instances where customers | | product |
| | received the wrong product | | |
| | | Received Greater | Customer did place an order but they |
| | | Quantity | received a greater quantity than they |
| | | | ordered. |
| Return & Refund | Customer is looking to start a | Return Setup | Customer is looking to start a return |
| | return for an item they received | | for an item they received. This does |
| | (includes cases where they | | NOT include instances where |
| | tried cancellation and were | | customer attempted to cancel |
| | advised it failed and they need | | beforehand |
| | to return). Also includes, return | | |
| | cancellation requests, return | | |
| | confirmation, return label | | |
| | requests, pickup/dropoff | | |
| | choices. In addition, | | |
| | informational contacts related | | |
| | to return confirmation, return | | |
| | policy and return process are | | |
| | included | | |
| | | Return Setup | Customer is looking to exchange an |
| | | (Exchange) | item for a different |
| | | | size/color/pattern/etc. |
| | | Return Setup | Customer tried to cancel previously |
| | | (Cancellation | but the cancellation did not go |
| | | Failure) | through, and they want to return the |
| | | | item (without paying for shipping) |
| | | Return | Customer is looking to cancel a |
| | | Cancellation | return that has been set up |
| | | Return | Customer is looking to confirm either |
| | | Confirmation/Failure | that the return has been setup, that |
| | | | the return has been received by |
| | | | carrier or in cases where they |
| | | | refused delivery, but the return was |
| | | | rejected |
| | | Return Label | Customer wants to receive a copy of |
| | | | their return label either because they |
| | | | can't find it or because they did not |
| | | | receive it. |
| | | Return Pickup | Customer is requesting for us to pick |
| | | | up the returned item from their |
| | | | residence and/or asking about pickup |
| | | | process or to change the date of the |
| | | | pickup |
| | | Return Policy | Customer is looking to understand if |
| | | | they are able to return an item and |
| | | | under what terms (if they have to pay |
| | | | for shipping) |
| | | Return Shipping | Customer does not want to pay |
| | | Waive Request | shipping for the return and is asking |
| | | | to waive it. Customer can also try |
| | | | requesting free shipping labels |
| | | Return Process | Customer wants to get more detail on |
| | | | what the return process is like with a |
| | | | pickup and dropoff and set |
| | | | expectations with refund timing |
| | | Refund/Discount | Customer is looking to get a refund |
| | | Request for Unmet | on an item due to unmet expectations |
| | | Expectations or | or buyer's remorse |
| | | Buyer's Remorse | |
| | | Refund Question | Customer is looking to get detail on |
| | | | timing of the refund and/or the |
| | | | amount of the refund that they are |
| | | | supposed to receive. Does NOT |
| | | | include requesting a refund. |
| | | Return | Customer received the original item |
| | | Replacement Item | and a replacement (usually in cases |
| | | | where original was presumed lost in |
| | | | transit). They want to return the |
| | | | replacement to us |
| Order Question | Customer wants to get an | Order Status | Customer wants to get an update on |
| | update on arrival time of their | | the status of their item or order. |
| | item/order. Includes cases | | Includes asking for arrival date and/or |
| | where customer is asking | | time of their item as well as whether |
| | about a late shipment or | | an item has shipped. This does not |
| | delivery or sees that the item | | include questions about late |
| | has not moved in a while. Also | | deliveries or shipments. |
| | includes cases where | | |
| | Customer wants to clarify our | | |
| | delivery process like needing to | | |
| | be home to accept delivery, | | |
| | different levels of delivery | | |
| | service (inside home drop-off, | | |
| | etc. | | |
| | | Late Delivery | Customer is inquiring about why |
| | | Question | delivery is arriving later than they |
| | | | expected. This does not include a |
| | | | status check of the shipment. |
| | | Late Shipment | Customer is wondering why their item |
| | | Question | has not shipped yet. |
| | | Item Not Moving | Customer is wondering why their item |
| | | | has not moved. Includes cases |
| | | | where customer received a shipping |
| | | | notification and/or has been tracking |
| | | | a shipped item but did not see the |
| | | | package move. |
| | | Delivery Process | Customer wants to clarify our delivery |
| | | | process like needing to be home to |
| | | | accept delivery, different levels of |
| | | | delivery service (inside home drop- |
| | | | off, etc.) |
| | | Reschedule | delivered on a different day (either |
| | | Delivery Date/Time | Customer is trying to get the item |
| | | | earlier or later than the current |
| | | | delivery estimate) and/or is trying to |
| | | | specify a time for the item to be |
| | | | delivered |
| | | Missing Tracking | Customer wants to know why their |
| | | Information | order does not have tracking |
| | | | information available yet or wants to |
| | | | retrieve the missing tracking |
| | | | information |
| | | Missing Estimated | Customer is missing an estimated |
| | | Delivery Date | delivery date and wants to know the |
| | | | date (and time window if applicable) |
| | | | they can expect their order to be |
| | | | delivered |
| | | Item Still | Customer wants to know why their |
| | | Processing | order is still processing/pending |
| | | | shipment and when they can expect |
| | | | their order to ship out. Includes why it |
| | | | is on hold (either by the retailer or the |
| | | | carrier). |
| | | Shipment | Customer wants to know if their order |
| | | Confirmation | has shipped yet and what date their |
| | | | order shipped |
| | | On-Time | Customer wants to know if their order |
| | | Confirmation | is still on track to be delivered on time |
| | | | or customer wants to know if the |
| | | | current delivery date is still accurate |
| | | Backorder | Customer wants to know why their |
| | | | order is backordered, when to expect |
| | | | their backordered item will be |
| | | | delivered or if the backorder delivery |
| | | | date will change again |
| Product | Question on the product | Product Question | Question on the product |
| Question | specifications/attributes (NOT | | specifications/attributes (NOT price |
| | price related) on either a new | | related) on either a new order or an |
| | order or an existing one (i.e., is | | existing one (i.e., is the chair made of |
| | the chair made of wood or | | wood or plastic?) |
| | plastic?) | | |
| Sales | Customer is looking to make a | Sales | Customer is looking to make a new |
| | new purchase. This includes | | purchase. This includes cases where |
| | cases where customer is trying | | customer is trying to buy an item that |
| | to buy an item that was | | was cancelled/returned/dnd'ed/ |
| | cancelled/returned/dnd'ed/back | | backordered/out of stock |
| | ordered/out of stock | | |
| Warranty | Customer is looking for more | Warranty | Customer is looking for more |
| | information on a warranty. | | information on a warranty. This |
| | Includes requests to cancel the | | includes requests to cancel the |
| | warranty | | warranty |
| Retailer Credit | Customer has questions | Retailer Credit | Customer has questions regarding |
| Card | regarding the retailer credit | Card | the retailer credit card. It could be |
| | card. It could be related to | | related to application, promotion, |
| | application, promotion, charges | | charges and payments |
| | and payments | | |
| Write a Review | Customer would like to write a | Write a Review | Customer wants to write a review for |
| | Wayfair product review. | | a recently purchased item and wants |
| | | | to know where they can leave their |
| | | | feedback. |
| Wrong Product | Customer received a product | Wrong Size | Customer claims to have received an |
| | that was either completely | Received | item that was the wrong size (i.e., |
| | wrong (i.e., coffee mug instead | | queen bed instead of kind bed) |
| | of a table), wrong color/size or | | |
| | did not match product | | |
| | description on our website. | | |
| | This also includes instances | | |
| | where customer receives a | | |
| | wrong part for the item (i.e., 2 | | |
| | right legs for a chair instead of | | |
| | 1 right and 1 left) | | |
| | | Wrong Color | Customer received an item that is the |
| | | Received | wrong color |
| | | Inconsistent | Customer received an item that does |
| | | Image/Description | not look like the one in the |
| | | | picture/description on our website |
| | | Wrong Item | Customer received an entirely wrong |
| | | Received | item (i.e., coffee mug instead of a |
| | | | table) |
| | | Wrong Parts | Customer received some incorrect |
| | | Received | parts (i.e., 2 right legs for a chair |
| | | | instead of 1 right and 1 left) |

In some embodiments, the intent prediction module 222 may identify an intent of the caller based on the candidate intent(s) and the associated score(s). In some embodiments, when the output of the first trained ML model indicates one candidate intent, that candidate intent may be identified as the intent of the caller. In other embodiments, when the output of the first trained ML model indicates multiple candidate intents, the intent of the caller may be identified based on the candidate intent scores. For example, the candidate intent having the highest candidate score may be identified as the intent of the caller.

In some embodiments, the first trained ML model is a trained language model comprising a trained neural network having a transformer architecture as described above. The first trained ML model comprises between 100 and 500 million parameters. Any suitable range of parameters (e.g., 100 million-1 billion, 100 million-250 million, 500 million-2 billion, 1 billion-10 billion or any suitable range within these ranges) may be used as aspects of the disclosure are not limited in this respect. As another example, at least 100 million, 250 million, 500 million, 1 billion, 2 billion, 5 billion, 10 billion, 100 billion parameters or any other suitable number or range of parameters may be used. In some embodiments, processing the caller data using the first trained ML model comprises calculating the output indicating the candidate intent(s) and associated score(s) using the caller data and values of the parameters.

In an example implementation, the first trained ML model takes as input a maximum of 128 tokens of the textual input/utterance(s). Longer input is truncated to 128 tokens. The first trained ML model is a fine-tuned RoBERTa base model from the Hugging Face Python library, containing 128 million parameters, and using a PyTorch backend. The first trained ML model utilizes one fully connected layer with a dimension of 87 to handle all intents for the intent classification task. The model uses BCEWithLogitsLoss as the loss function for multi-label classification. To optimize the model during training and prevent overfitting, the Adam optimizer is chosen with a learning rate of 0.00001, epsilon of 0.000001, and weight decay coefficient of 0.01. Bias correction in the optimizer is disabled. This configuration ensures effective training and regularization for the model to excel in the given classification problem. Being a multi-label model, the first trained ML model can predict multiple intents simultaneously with varying scores, accommodating the complexity of user needs during interactions. To determine the most likely intent, score thresholds are learned using a holdout validation set. The selected intent is an intent (e.g., an intent listed in the third column in Table 1) whose score is farthest above the learned threshold and that intent is mapped to one of intents listed in the first column of Table 1. This approach allows the first trained ML model to make accurate intent predictions and better understand the caller's varied intents during their interaction with the communication management system 250 (e.g., via the virtual assistant). Other trained language models may be used without departing from the scope of this disclosure.

In some embodiments, obtaining the caller data may include obtaining data about the caller's historical behavior (e.g., caller's behavior prior to initiation of the communication session). This data may include, but not be limited to, information about the caller's previous orders (e.g., number, type, and pricing of orders placed), information about the caller's browsing behavior on the retailer's online shopping platform (e.g., recent products viewed by the caller, recent interactions, such as clicks, with the graphical user interface of the online shopping platform (e.g., website interactions, etc.)), information about the caller's purchasing behavior (e.g., number of items purchased in the last year and their prices), information about the caller's contact history (e.g., a number of times the caller contacted the contact center in the past year), information about product incidents (e.g., a number of times an interaction with the caller lead to a product incident report), and fulfillment details (e.g., details on inventory management, packing, shipping, delivery, and returns of purchased items). Such historical data about callers may be stored in the database 260.

In some embodiments, the intent prediction module 222 may include a second trained ML model that is configured to predict intent of callers using features derived from data about callers' historical behavior. In some embodiments, the second trained ML model may identify the intent of the caller by processing the caller data using the second trained ML model to obtain output indicating one or more candidate intents and associated one or more scores. In some embodiments, the second trained ML model may take as input features derived from data about the callers' historical behavior and other types of data (e.g., data obtained from the caller itself (such as caller information, order information, etc.), product history data, and/or other data). It will be appreciated that the second trained ML model is not limited to using features derived only from the historical data and can use one or more other inputs as aspects of the disclosure are not limited in this respect.

In some embodiments, the features derived from data about the callers' historical behavior may include behavior features selected from the group consisting of at least 10 features selected from the features listed in Table 2. Any suitable number of features (e.g., less than 10, greater than 10, or all the features in Table 2) may be derived and used by the second trained ML model as aspects of the disclosure are not limited in this respect. These derived behavior features may be stored in the database 260 and obtaining data about the caller's historical behavior may include obtaining the behavior features from the database 260.

TABLE 2

| Feature | Feature Description | Importance Score |
|---|---|---|
| Latest Shipping Status-minimum hours till | Minimum hours until the estimated | 7.752362726 |
| estimated delivery | delivery, according to the latest | |
| | shipping status of an order | |
| Latest order details-hour since delivered | Hours since the latest order item was | 6.362765606 |
| | delivered. | |
| Latest order details-hours since ordered | Hours since the latest order item was | 5.625589801 |
| | ordered. | |
| Latest order details-ordered product | Weight of the product for the latest | 4.619236011 |
| weight | order item. | |
| Latest self-service session-Start path | The starting path of the latest self- | 3.646683271 |
| name | service session. | |
| Latest order details-hours since shipped | Hours since the latest order item was | 3.264254207 |
| | shipped. | |
| Latest self-service session-hours since | Hours since the start of the latest self- | 3.121213975 |
| start | service session. | |
| Latest order details-status ID | The ID associated with the latest status | 2.886236707 |
| | of the order item | |
| In return indicator | Indicator if an item is currently in | 2.84878857 |
| | return. | |
| Shipping status count-1 hr overdue | Number of order items with overdue | 2.805650188 |
| delivery | delivery in the last hour. | |
| Latest Shipping status-minimum hours | Minimum hours since the latest order | 2.710301046 |
| since delivered | item was delivered. | |
| Latest shipping status-maximum hours | Maximum overdue hours of the latest | 2.603836602 |
| overdue shipment | shipment. | |
| Latest order details-shipping email sent | Indicator if shipping email for the latest | 2.339410794 |
| | order item was sent. | |
| Uber wizard latest run-possessed items | Information from the latest run of the | 2.311063472 |
| | uber wizard about possessed items. | |
| Incident rates-rate return | A customer's historical return rate. | 2.121701536 |
| Uber wizard latest run-remaining revenue | Remaining revenue as determined by | 2.063494007 |
| | the latest run of the uber wizard. | |
| Latest shipping status-minimum hours | Minimum hours since the latest order | 1.558393528 |
| since shipped | item was shipped. | |
| Latest cancellation success-hours since | Hours since the last successful order | 1.545153394 |
| | cancellation. | |
| Average historical incident rates for SKU- | Average historical rate of return for | 1.411859127 |
| average rate of return | SKUs ordered by the customer. | |
| Out for delivery-12 to1 hours | Order items that were out for delivery | 1.30969865 |
| | between 12 to 1 hours ago. | |
| Service calls history count | The total number of service calls a | 1.150819007 |
| | customer has made in their history with | |
| | the company. | |
| Uber wizard latest run-medic | Was a medic resolution offered during | 1.113902202 |
| | the latest run of the uber wizard. | |
| Pending cancellations | Whether there are any pending | 1.096349923 |
| | cancellations for the customer's latest | |
| | order. | |
| Uber wizard latest run-hours since | The number of hours that have passed | 1.012532754 |
| | since the ‘uber wizard’ tool was last | |
| | run. | |
| Latest shipping status-minimum hours till | The minimum number of hours until the | 1.009947681 |
| estimated shipment | estimated shipment of the customer's | |
| | most recent order item. | |
| Out for delivery-1 to 7 days | If the customer's latest order item was | 0.9528997327 |
| | out for delivery between 1 to 7 days | |
| | ago. | |
| Shipped-1 to 7 days | If the customer's latest order item was | 0.9522792644 |
| | shipped between 1 to 7 days ago. | |
| Latest replacement status | The current status of any replacement | 0.9079932525 |
| | items for the customer. | |
| Years since first order | The number of years that have passed | 0.8720015054 |
| | since the customer's first order. | |
| Incident rates | The rate of incidents, such as issues | 0.8601282345 |
| | with orders or customer service, for the | |
| | customer. | |
| Expected costs-30 day | The expected costs associated with the | 0.8320338962 |
| | customer related to gross incidence | |
| | exposure for the next 30 days. | |
| Latest shipping status-minimum hours | The minimum number of hours that an | 0.8163470763 |
| overdue shipment | item in the customer's latest order is | |
| | overdue shipment. | |
| Latest order details-sell new as used | If the customer's most recent order | 0.7472594638 |
| | involved selling a new item as used. | |
| Shipping status count-12 to 1 hrs- | The number of times a delivery has | 0.7030000063 |
| overdue delivery | been overdue between 1 to 12 hours | |
| | for the customer. | |
| Average historical incident rates for SKU- | The average historical incident rate for | 0.6504770241 |
| average rate replacement unit | replacement unit for each SKU ordered | |
| | by the customer. | |
| Cancellation attempt-1-7 days | Whether there have been any | 0.6485028323 |
| | cancellation attempts for the | |
| | customer's orders within the last 1 to 7 | |
| | days. | |
| Latest shipping status-maximum hours | The maximum number of hours that | 0.5727082634 |
| overdue delivery | the customer's item has been overdue | |
| | for delivery. | |
| Latest order details-original product price | The original price of the product in the | 0.5726127417 |
| | customer's most recent order details. | |
| Expected costs-returns 30 day | The expected gross costs associated | 0.5582057898 |
| | with product returns from the customer | |
| | over the next 30 days. | |
| Latest shipping status-minimum hours | The minimum number of hours that the | 0.5570642751 |
| overdue delivery | customer's most recent shipment is | |
| | overdue for delivery. | |
| Shipping fulfillment status count-within 1- | The count of fulfilled and delivered | 0.5534910814 |
| 7 days | orders within the last 1 to 7 days. | |
| Average historical incident rates for SKU- | The highest historical incident rate for | 0.5490555338 |
| maximum rate | any SKU ordered by the customer. | |
| Uber wizard latest run-discount payment | Payment method to which a discount | 0.5403040209 |
| method | was applied on the latest uber wizard | |
| | run for the customer | |
| Latest order details-kit quantity | The quantity of items in the kit from the | 0.4883736395 |
| | customer's most recent order details. | |
| Shipping status count-7-30 days | The count of shipped orders within the | 0.457722392 |
| | last 7 to 30 days. | |
| Uber wizard latest run-start path | The start path for the latest run of the | 0.4515631902 |
| | ‘uber wizard’ tool. | |
| Average historical incident rates for SKU- | The average historical incident rate for | 0.4490189338 |
| average rate replacement part | replacement parts for each SKU | |
| | ordered by the customer. | |
| Average historical incident rates for SKU- | The maximum historical incident rate | 0.4387069423 |
| maximum rate replacement unit | for replacement units for each SKU | |
| | ordered by the customer. | |
| Rejected cancellation-1-7 days | Whether there have been any rejected | 0.4285215234 |
| | cancellation attempts for the | |
| | customer's orders within the last 1 to 7 | |
| | days. | |
| Latest order details-product price | The price of the product in the | 0.422375697 |
| | customer's most recent order details. | |
| Ship class name count-1-7 days-small | The count of small parcel shipments | 0.4172169103 |
| parcel | within the last 1 to 7 days. | |
| Average historical incident rates for SKU- | The highest historical incident rate | 0.4123243361 |
| maximum rate discount to keep | related to discount-to-keep (DTK) for | |
| | each SKU ordered by the customer. | |
| Order lifetime count | The total count of orders placed by the | 0.4011230202 |
| | customer over their lifetime with the | |
| | company. | |
| Contact us latest run-question answer 4 | The fourth question-answer pair from | 0.3951642921 |
| | the customer's most recent interaction | |
| | with the ‘Contact Us’ function. | |
| Self-service latest run-hours since | The number of hours since the | 0.3853113582 |
| complete | customer last successfully completed a | |
| | self-service activity. | |
| Latest replacement status-hours till | The estimated number of hours until | 0.3840148867 |
| estimated delivery | the delivery of a replacement item for | |
| | the customer's order. | |
| Latest order details-tax | The amount of tax associated with the | 0.3630880726 |
| | customer's most recent order item. | |
| Uber wizard latest run-issued save | Any specific attribute or outcome | 0.3438229867 |
| coupon | related to issuing a ‘save coupon’ from | |
| | the latest run of the ‘uber wizard’ tool. | |
| Average historical incident rates for SKU- | The highest historical incident rate | 0.3413391346 |
| maximum rate return | related to returns for each SKU | |
| | ordered by the customer. | |
| Latest replacement status-hours since | The number of hours since a | 0.3359019303 |
| requested | replacement for the customer's order | |
| | was requested. | |
| Shipping fulfillment status count-1-12 | The count of out-for-delivery items | 0.3220130645 |
| hours-out for delivery | within the last 1 to 12 hours. | |
| Lifetime costs-Gross lifetime | The gross revenue associated with the | 0.3152629719 |
| | customer over their lifetime with the | |
| | company. | |
| Uber wizard latest run-item installed | Any specific attribute or outcome | 0.292697276 |
| | related to item installation from the | |
| | latest run of the ‘uber wizard’ tool. | |
| Ship class name count-1-7 days-does | The count of non-existent shipment | 0.2907872348 |
| not exist | class names within the last 1 to 7 days. | |
| Average historical incident rates for SKU- | The maximum historical incident rate | 0.2905852041 |
| maximum rate replacement part | per replacement part for each SKU | |
| | ordered by the customer. | |
| Self-service abandoned start reason count-1-7 | The count of instances where | 0.2791817824 |
| days-returns | customers abandoned the self-service | |
| | process due to returns in the last 1 to 7 | |
| | days. | |
| Latest order details-reorder default | The default reorder details from the | 0.2779929328 |
| | customer's most recent order. | |
| Return created-1-7 days | Whether a return was created for any | 0.2735110437 |
| | of the customer's orders within the last | |
| | 1 to 7 days. | |
| Shipping fulfillment status count-7-30 | The count of delivered items within the | 0.2727334287 |
| days-delivered | last 7 to 30 days. | |
| Uber wizard start count-1-7 days-where | The count of ‘uber wizard’ tool starts | 0.2652991756 |
| is my stuff (wims) workflow | within the last 1 to 7 days for the | |
| | ‘wimsworkflow’ function. | |
| Average historical incident rates for SKU- | The average historical incident rate for | 0.2616832188 |
| average rate incident | each SKU ordered by the customer. | |
| Lifetime costs-GIE lifetime | The gross incidence exposure (GIE) | 0.2575591283 |
| | associated with the customer over their | |
| | lifetime with the company. | |
| Shipping fulfillment status count-1-12 | The count of delivered products within | 0.2535775937 |
| hours-delivered | the last 1 to 12 hours. | |
| Shipping action count-1-7 days- | The count of fulfillment actions related | 0.2506825118 |
| fulfillment shipped | to shipments within the last 1 to 7 days. | |
| Rejected cancellation-7-30 days | Whether there have been any rejected | 0.2452158229 |
| | cancellation attempts for the | |
| | customer's orders within the last 7 to | |
| | 30 days. | |
| Latest order details-transshipment | Whether transshipment is intended for | 0.2446832868 |
| | the customer's most recent order. | |
| Shipping fulfillment status count-1-12 | The count of non-existent order | 0.2347040234 |
| hours-does not exist | fulfillment statuses within the last 1 to | |
| | 12 hours. | |
| Ship class name count-7-30 days- | The count of large parcel shipments | 0.2308223976 |
| large parcel | within the last 7 to 30 days. | |
| Shipping fulfillment status count-1-7 days- | The count of shipped items within the | 0.2217940324 |
| shipped | last 1 to 7 days. | |
| Uber wizard latest run-recommended | The recommended resolution from the | 0.2156711411 |
| resolution | latest run of the ‘uber wizard’ tool. | |
| Ship class name count-1-12 hours-does | The count of non-existent shipment | 0.2129351657 |
| not exist | class names within the last 1 to 12 | |
| | hours. | |
| Contact us latest run-hours since | The number of hours since the | 0.2124707816 |
| | customer's last interaction with the | |
| | ‘Contact Us’ function. | |
| Shipping fulfillment status count-12 hours-1 | The count of order products delivered | 0.2092025938 |
| day-delivered | within the last 12 hours to 1 day. | |
| Return created-7-30 days | Whether a return was created for any | 0.200189452 |
| | of the customer's orders within the last | |
| | 7 to 30 days. | |
| Latest order details-original insurance cost | The original cost of the product | 0.1990033021 |
| | insurance in the customer's most | |
| | recent order details. | |
| Shipping status count-1 hour-shipping | The count of products in the shipping | 0.1972969682 |
| | process within the last hour. | |
| Shipping status count 1-12 hours- | The count of overdue shipments within | 0.1954212361 |
| overdue shipment | the last 1 to 12 hours. | |
| Shipping fulfillment status count-1-7days- | The count of partially delivered orders | 0.1944645659 |
| partially delivered | within the last 1 to 7 days. | |
| Self-service abandoned start reason count-1-7 | The count of instances where | 0.193371271 |
| days-report a problem workflow | customers abandoned the self-service | |
| | process related to reporting a problem | |
| | within the last 1 to 7 days. | |
| Average historical incident rates for SKU- | The average historical incident rate | 0.1910531517 |
| average rate refund | related to refunds for each SKU | |
| | ordered by the customer. | |
| Order confirmed non-replacement-1-7 | Whether there have been any | 0.1872001752 |
| days | confirmed, non-replacement orders | |
| | within the last 1 to 7 days. | |
| Average historical incident rates for SKU- | The average historical incident rate | 0.1826685383 |
| average rate DTK | related to discount-to-keep (DTK) for | |
| | each SKU ordered by the customer. | |
| Shipping status count-1 hour-overdue | The count of overdue shipments within | 0.1810871091 |
| shipment | the last hour. | |
| Lifetime-costs-GIE-GRS lifetime ratio | The lifetime ratio of Gross Incidence | 0.1694752855 |
| | Exposure to Gross Revenue Stable | |
| | (GIE to GRS) for the customer. | |
| Latest cancellation-reason | The reason for the most recent | 0.1524970944 |
| | successful cancellation of an order. | |
| Viewed warranty of order product-1-12 | Whether the warranty of an order | 0.1507875769 |
| hours | product was viewed within the last 1 to | |
| | 12 hours. | |
| Shipping status count-1-7 days-shipped | The count of shipped orders within the | 0.1479680963 |
| | last 1 to 7 days. | |
| Self-service latest run-resolution name | The name of the resolution from the | 0.1430584366 |
| | latest run of the self-service tool. | |
| Latest order details-promotional details | Any promotional details from the | 0.1378886121 |
| | customer's most recent order. | |
| Shipping fulfillment status count-12 hours | The count of shipped orders within the | 0.1355876728 |
| to 1 day-shipped | last 12 hours to 1 day. | |
| Self-service abandoned start reason count-12 | The count of instances where | 0.1219733357 |
| hours-1 day-returns | customers abandoned the self-service | |
| | process due to returns in the last 12 | |
| | hours to 1 day. | |
| Shipping status count-1 to 12 hours- | The count of products in the shipping | 0.1211377771 |
| shipping | process within the last 1 to 12 hours. | |
| Shipping fulfillment status count-7-30 | The count of products with fulfillment | 0.1132830663 |
| days-fulfillment shipped | shipped status within the last 7 to 30 | |
| | days. | |
| Shipping status count-1 hour-pending | The count of products with pending | 0.112753877 |
| shipment | shipment status within the last hour. | |
| Shipping status count 0 1-12 hours- | The count of products with pending | 0.1113715702 |
| pending shipment | shipment status within the last 1 to 12 | |
| | hours. | |
| Cancellation attempt-12hours-1 day | Whether there have been any | 0.1074505786 |
| | cancellation attempts for orders within | |
| | the last 12 hours to 1 day. | |
| Ship class name count-1-12 hours-small | The count of small parcel shipments | 0.1046230614 |
| parcel | within the last 1 to 12 hours. | |
| Shipping action count-1-7 days- | The count of fulfillment actions | 0.09852655877 |
| fulfillment out for delivery | indicating ‘out for delivery’ within the | |
| | last 1 to 7 days. | |
| Multi item orders count-1-7 days | The count of orders containing multiple | 0.09559452276 |
| | items within the last 1 to 7 days. | |
| Shipping fulfillment status count-7-30 | The count of partially delivered orders | 0.09453669876 |
| days-partially delivered | within the last 7 to 30 days. | |
| Order confirmed non-replacement-12 | Whether there have been any | 0.09157953635 |
| hours-1 day | confirmed, non-replacement orders | |
| | within the last 12 hours to 1 day. | |
| Multi item orders count-7-30 days | The count of orders containing multiple | 0.08962762897 |
| | items within the last 7 to 30 days. | |
| Latest order details-is a return | Whether the most recent order is a | 0.08136384046 |
| | return. | |
| Contact us latest run-path id | The ID of the path for the customer's | 0.08126727415 |
| | most recent interaction with the | |
| | ‘Contact Us’ function. | |
| Incident rates-rate replacement unit | Customers historical incident rate for | 0.079522925 |
| | replacement units. | |
| Shipping status count-1 hour-ordered | The count of products with the status | 0.07333291595 |
| | ‘ordered’ within the last hour. | |
| Shipping action count-12 hours-1 day- | The count of non-existent fulfillment | 0.07312793367 |
| does not exist | actions within the last 12 hours to 1 | |
| | day. | |
| Cancellation attempt-7-30 days | Whether there have been any | 0.07256993376 |
| | cancellation attempts for orders within | |
| | the last 7 to 30 days. | |
| Contact us storeID count-1 hour-does | The count of non-existent store IDs | 0.07083913681 |
| not exist | associated with ‘Contact Us’ within the | |
| | last hour. | |
| Shipping status count 1-7 days overdue | The count of overdue deliveries within | 0.06622068545 |
| delivery | the last 1 to 7 days. | |
| Self-service abandoned start reason count-1 | The count of instances where | 0.063521623 |
| hour-does not exist | customers abandoned the self-service | |
| | process for non-existent reasons within | |
| | the last hour. | |
| Shipping action count-1-12 hours- | The count of fulfillment actions | 0.05971033033 |
| fulfillment out for delivery | indicating ‘out for delivery’ within the | |
| | last 1 to 12 hours. | |
| Back ordered-1-7 days | Whether an item in a customer's order | 0.05865931179 |
| | has been backordered within the last 1 | |
| | to 7 days. | |
| Contact us latest run-source id | The ID of the source from the | 0.05803382458 |
| | customer's most recent interaction with | |
| | the ‘Contact Us’ function. | |
| Shipping action count-1-12 hours-does | The count of non-existent fulfillment | 0.05734801156 |
| not exist | actions within the last 1 to 12 hours. | |
| Contact us contact-platformID count-1-7 | The count of non-existent platform IDs | 0.05596388034 |
| days-does not exist | associated with ‘Contact Us’ within the | |
| | last 1 to 7 days. | |
| Shipping status count-12 hours to 1 day- | The count of products with pending | 0.05459019307 |
| pending shipment | shipment status within the last 12 | |
| | hours to 1 day. | |
| Shipping action count-7-30 days- | The count of fulfillment actions | 0.05198288186 |
| fulfillment shipped | indicating a shipment within the last 7 | |
| | to 30 days. | |
| Self-service finished incident count-1-7 | The count of instances where a | 0.05071579801 |
| days-defective | defective product led to a finished self- | |
| | service interaction within the last 1 to 7 | |
| | days. | |
| Self-service finished start reason count-1- | The count of instances where | 0.04654797572 |
| 7 days-report a problem workflow | customers reported a problem as the | |
| | start reason and finished the self- | |
| | service process within the last 1 to 7 | |
| | days. | |
| Replacement latest status-hours overdue | The number of hours an order | 0.04612739814 |
| delivery | replacement is overdue for delivery. | |
| Replacement status count-1-12 hours- | The count of pending shipment | 0.04430920234 |
| pending shipment | statuses for replacements within the | |
| | last 1 to 12 hours. | |
| Shipping latest status-minimum hours | The minimum number of hours since | 0.04269845931 |
| since ordered | the latest order was made. | |
| Shipping fulfillment status count-1-12 | The count of shipped orders within the | 0.04236038926 |
| hours-shipped | last 1 to 12 hours. | |
| Incident rates-rate DTK | The customers historical incident rate | 0.04118677282 |
| | associated with discount-to-keep (DTK) | |
| | resolutions. | |
| Self-service abandoned start reason count-1 | The count of instances where | 0.03804988514 |
| hour-report a problem workflow | customers reported a problem and | |
| | abandoned the self-service process | |
| | within the last hour. | |
| Contact us pathid count-1-7 days-does | The count of non-existent paths in | 0.0354708243 |
| not exist | ‘Contact Us’ interactions within the last | |
| | 1 to 7 days. | |
| Contact us contactplatformID count-1 | The count of non-existent platform IDs | 0.03450824196 |
| hour-does not exist | associated with ‘Contact Us’ within the | |
| | last hour. | |
| Shipped-7-30 days | Whether any items in a customer's | 0.03361617958 |
| | order have been shipped within the last | |
| | 7 to 30 days. | |
| Uber wizard recommended resolution count- | The count of instances where the ‘uber | 0.03268421698 |
| 1-7 days-return | wizard’ tool recommended a return | |
| | within the last 1 to 7 days. | |
| Order confirmed non-replacement 7-30 | Whether there have been any | 0.03160722426 |
| days | confirmed, non-replacement orders | |
| | within the last 7 to 30 days. | |
| Self-service abandoned start reason | The count of instances where | 0.03135687521 |
| count-1-7 days-change ship speed | customers attempted to change | |
| | shipping speed and abandoned the | |
| | self-service process within the last 1 to | |
| | 7 days. | |
| Replacement latest status-hours till | The estimated number of hours until | 0.03084934175 |
| estimated shipment | the latest replacement item is shipped. | |
| Shipped-12 hours to 1 day | Whether any items in a customer's | 0.03083254145 |
| | order have been shipped within the last | |
| | 12 hours to 1 day. | |
| Uber wizard start count-1-7 days- | The count of instances where the ‘uber | 0.0282867367 |
| damage defect workflow | wizard’ tool was started with the reason | |
| | of a damaged or defective product | |
| | within the last 1 to 7 days. | |
| Replacement status count-1 hour- | The count of shipping statuses for | 0.02684999545 |
| shipping | replacements within the last hour. | |
| Ship class name count-1-12 hours- | The count of large parcel shipments | 0.02438848871 |
| large parcel | within the last 1 to 12 hours. | |
| Replacement latest status-hours since | The number of hours since the latest | 0.01979385226 |
| shipped | replacement item was shipped. | |
| Contact us contactplatformID ‘2’ count-1- | The count of interactions with ‘Contact | 0.01357339027 |
| 7 days | Us’ on platform ID ‘2’ within the last 1 | |
| | to 7 days. | |
| Replacement latest status-hours since | The number of hours since the latest | 0.0103909165 |
| cancelled | replacement was cancelled. | |

In some embodiments, the second trained ML model is a gradient boosted decision tree model. The gradient boosted decision tree model may comprise between 250 and 750 decision trees. Any suitable range of decision trees (e.g., 100-300, 200-400, 300-500, 400-600, 500-700, 600-800, etc.) may be used as aspects of the disclosure are not limited in this respect.

In some embodiments, the second trained ML model may identify the intent of the caller by processing the caller data (e.g., caller's historical data or other data) using the second trained ML model to obtain output indicating candidate intent(s) (e.g., intent(s) selected from the group of intents listed in Table 1) and associated score(s).

In some embodiments, inputs to the second trained ML model may include features derived from the following categories: caller's order product information (e.g., caller's order-product replacement latest status), customer order history (e.g., first years since first order), shipping information (e.g., carrier information), billing information (e.g., applied for retailer credit card), storefront browsing information (e.g., customer viewed product warranty within a particular timeframe), and/or other categories.

In some embodiments, inputs to the second trained ML model may include caller-specific features detailing historical purchase behavior, contact history, product incidents, and fulfillment details. A primary group of features used by the model are temporal related to the latest post-order event (shipment, delivery, service contact), historical incident, and contact rates for the caller's purchased items. A secondary group of features used by the model may include, but not be limited to the following categories: contact_us, which describes customer contact frequency and type within specific time frames; ‘self_service’ and ‘uber_wizard’ features indicating how the customer interacts with self-help resources and automated workflows run during service contacts; service_calls_history_count’, ‘order_lifetime_count’, and ‘years_since_first_order’ providing details about the customer's service calls, lifetime orders, and customer tenure, respectively. These features serve to comprehensively profile the customer's interaction history, transaction details, and behaviors. In some embodiments, the primary and/or secondary group of features to be provided as input to the second trained ML model may be selected based on their respective importance scores shown in Table 2.

In an example implementation, the second trained ML model is a CatBoost model. It includes a maximum of 500 decision trees, with a learning rate of 0.1, optimizing for accuracy on a holdout validation set. The model uses a random seed of 42 for reproducibility. It employs a maximum tree depth of 10 and applies L2 regularization to prevent overfitting. The second trained ML model predicts one or more candidate intents and outputs the candidate intent(s) and associated score(s). The second trained ML model was trained using training data consisting of 455 k phone contacts recorded between October 2022 and February 2023 (other suitable number of phone contacts and timeframes may be used without departing from the scope of this disclosure). The features used in the model were sourced from the Vertex feature store. The second trained ML model was trained on a historical set of input features to agent labeled wrap codes over a series of orders within a particular timeframe (e.g., within 6 months, 1 year, 2 years, 3 years, 4 years, or any other suitable timeframe). The ground truth for the model was derived from agent's call wraps (e.g., agent wrap codes used by agents to classify customer interactions, such as calls) and categorized into different intents, such as, assembly, returns, cancellations, billing/credits, report problem, shipping, order changes, and any other intent type listed in Table 1.

In some embodiments, the intent prediction module 222 may identify an intent of the caller based on the candidate intent(s) and the associated score(s). In some embodiments, when the output of the second trained ML model indicates one candidate intent, that candidate intent may be identified as the intent of the caller. In other embodiments, when the output of the second trained ML model indicates multiple candidate intents, the intent of the caller may be identified based on the candidate intent scores. For example, the candidate intent having the highest candidate score may be identified as the intent of the caller.

In some embodiments, the intent prediction module 222 may use caller data and/or product history information to identify an intent of the caller. For example, product history information about a product purchased by the caller may be collected over prior communication sessions with other callers who purchased, inquired, complained, or otherwise contacted the contact center regarding the product. Such information may include, but not be limited to, a purchase rate for the product, any product issues reported for the product and how often, a number of issues reported, a return rate for the product, and/or other product history information. Such information may be included in database 260 and may be used to derive features used as inputs to the second trained ML model.

In some embodiments, after the intent of the caller is identified, the agent identification module 224 identifies an agent to assign to the caller in the communication session by using the identified intent of the caller. In some embodiments, the agent identification module 224 identifies, from a plurality of agents 240a, 240b, 240c, an agent (e.g., agent 240c) to assign to the caller by using the identified intent of the caller and an agent performance model (APM). The APM is configured to rank at least some of the plurality of agents based on a measure of their performance in communication sessions with callers having a same intent as the intent of the caller (e.g., the intent identified by the intent prediction module 222). For example, if the intent prediction module 222 identifies the intent of the caller as “Damage/Defect,” the APM ranks at least some of the plurality of agents based on a measure of their performance in prior communication sessions with callers having the intent “Damage/Defect”.

In some embodiments, the APM indicates, for each of the plurality of agents and with respect to communication sessions with callers having the same intent as the intent of the caller, a plurality of performance scores for a corresponding plurality of performance indicators. As shown in FIG. 4A, a portion 400 of the APM for “Agent 1” indicates, for each intent of a plurality of intents (e.g., intents 1, 2, 3, 4 etc.), a plurality of performance scores for corresponding performance indicators (e.g., performance indicators 1, 2, 3, 4, etc.). The portion 400 of the APM may be generated by determining an agent's performance across various caller intents in prior communication sessions with the callers, and for each intent, determining the agent's performance scores for the various performance indicators.

In some embodiments, the plurality of performance indicators comprise performance indicators selected from the group consisting of one or more performance indicators listed in Table 3. Other performance indicators may also be used without departing from the scope of this disclosure. For example, customer conversion rate, gross revenue, and/or other performance indicators may be used.

TABLE 3

| PI | Name | Definition |
|---|---|---|
| PCSAT | perfect customer satisfaction | Percentage of the contacts a |
| | score | CSAT survey score (possible |
| | | scores are on the range of 1-5) |
| | | was a perfect 5. |
| FCR | first contact resolution | Was the customer's issue |
| | | resolved on the first time they |
| | | contacted the contact center? |
| | | Measured by whether or not the |
| | | same customer contacted |
| | | regarding the same order again |
| | | within 14 days. |
| LCR | low cost resolution | Did an eligible customer service |
| | | contact result in a low cost |
| | | resolution (like a discount or a |
| | | replacement part) rather than a |
| | | high cost resolution (like a full |
| | | refund or a full replacement |
| | | product)? |
| AHT | average handle time | Time an agent is on a call, |
| | | averaged over the course of the |
| | | period. |
| LIT | lost in transit compliance | Did the agent wait for 6 days |
| | | without a shipping scan before |
| | | offering to resolve a lost in transit |
| | | item? |
| RFC | return ship fees compliance | Did the agent follow the correct |
| | | procedure in charging the |
| | | customer for return shipping? |

In some embodiments, a measure of Agent l's performance in handling prior communication sessions with callers having a particular intent may be determined using a weighted combination of the plurality of performance scores (for various performance indicators) for that intent. For example, FIG. 4A shows the formula for calculating a measure of Agent 1's performance in communication sessions with callers having “Intent 4”. A measure of Agent 1's performance in communication sessions with callers having other intents, such as Intents 1, 2, 3, etc., may be determined in a similar manner. For example, a measure of Agent 1's performance in communication sessions with callers having “Intent 2” may be calculated using the formula below.

$${\sum }_{i = 1}^{Number of PIs} w ( i ) * score ( 2 , i )$$

FIG. 4B shows a portion 450 of the APM for multiple agents, such as agents 1, 2, 3, and 4. The portion 450 may be generated by determining each agent's performance across various caller intents in prior communication sessions with the callers, and for each intent, determining the agent's performance scores for the various performance indicators. The APM may include information regarding each agent's performance across various intents and performance indicators, which is depicted as matrices in FIG. 4B. Other mechanisms for calculating and storing this information may be used as aspects of the disclosure are not limited in this respect. In some embodiments, the weights and the performance scores may be determined prior to identifying the agent to assign to the caller using the identified intent of the caller and the APM.

In some embodiments, after each agent's measure of performance (also referred to herein as the overall performance score for the agent) across each intent is determined, a table 460 shown in FIG. 4C may be generated. Each row of the table corresponds to an agent. The table includes, for each agent, information about the agent (e.g., title, employment start date, the team that the agent is a member of, employee id, and/or other information) and the agent's measures of performance across each intent. As shown in FIG. 4C, column 471 corresponds to intent 1 and includes each agent's measure of performance in prior communication sessions with callers having intent 1, column 472 corresponds to intent 2 and includes each agent's measure of performance in prior communication sessions with callers having intent 2, column 473 corresponds to intent 3 and includes each agent's measure of performance in prior communication sessions with callers having intent 3, and column 474 corresponds to intent 4 and includes each agent's measure of performance in prior communication sessions with callers having intent 4.

In some embodiments, the overall performance scores indicated in the table are heuristic scores of a set of algorithms which identify an agent's skill at handling callers having a particular intent type. The performance scores may be normalized between zero and one for each intent type, as the output of the APM is used to rank an available set of agents for the current communication session between the caller 201 and the communication management system 250. The heuristic scoring algorithms may be based on the agent's performance across various performance indicators. Each of the intent types may have a different set of coefficients or weights for each of the performance indicators as some intent types do not correspond to some performance indicators.

In some embodiments, the table 460 corresponds to a portion of the APM that is used to rank at least some of the plurality of agents based on a measure of their performance in communication sessions with callers having a same intent as the intent of the caller. In some embodiments, identifying the agent to assign to the caller using the identified intent of the caller in the communication session and the APM comprises for each particular agent of the at least some of the plurality of agents, determining a measure of performance of the particular agent using weighted combination of the plurality of performance scores of the particular agent, thereby obtaining a plurality of measures of performance, and ranking the at least some of the plurality of agents using the plurality of measures of performance.

In some embodiments, ranking the at least some of the plurality of agents using the plurality of measures of performance comprises ranking available agents (i.e., agents who are available and can be assigned to the caller in the communication session) using their respective measures of performance. In some embodiments, identifying an agent to assign to the caller in the communication session by using the identified intent of the caller and the APM comprises identifying, from the ranked available agents, an agent with the highest measure of performance for the identified intent relative to the measures of performance for the other agents.

In some embodiments, the APM predicts an agent for handling a communication session with a caller based on each available agent's historical performance (e.g., measures of performance) for each intent type. For example, based on an identified intent of the caller in the communication session, the APM predicts an agent for handling the caller having the identified intent based on each available agent's measure of performance for that intent type.

In some embodiments, the APM accepts as input the identified intent of the caller in the communication session and outputs a ranked list of agents based on their measure of performance for the same intent as the identified intent. In cases where an intent may not be available, an intent agnostic ranking may be returned.

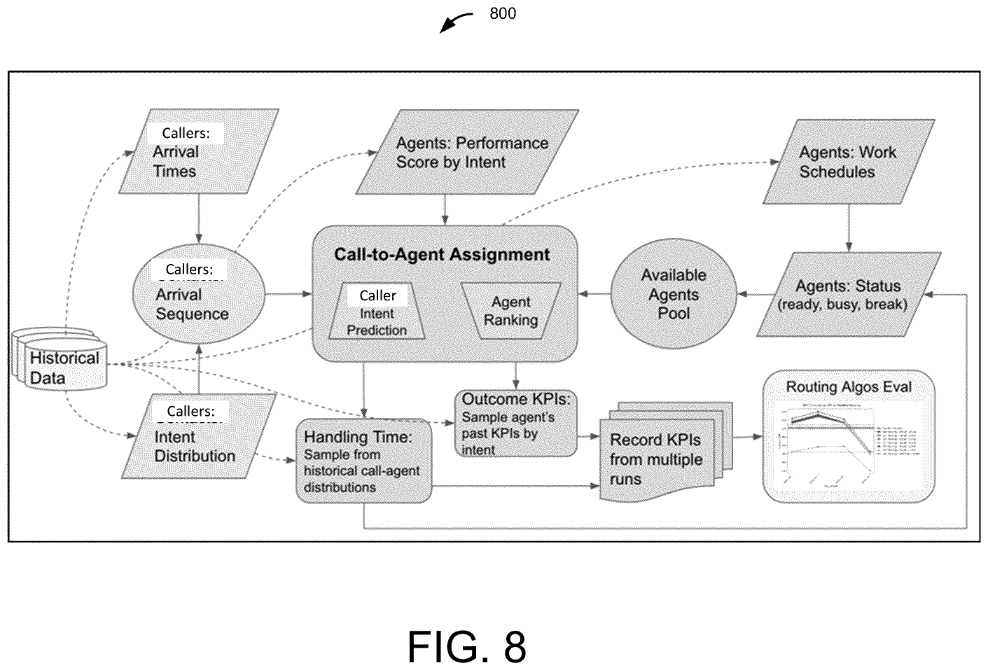

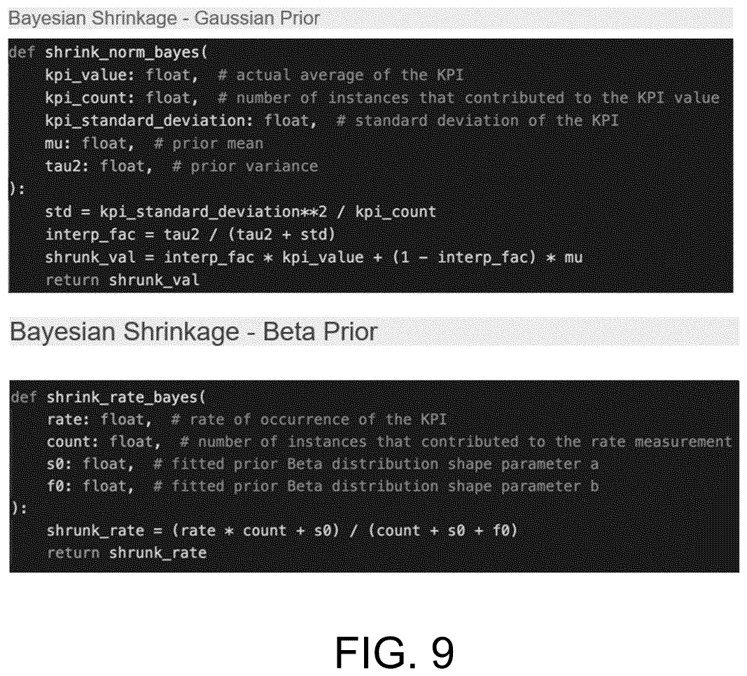

In an example implementation, the APM is retrained on a daily cadence including the previous 400 days of contacts. For the US Phone APM this accounts for 1.2 million callers across 1.8 k agents (other suitable caller and agent numbers or ranges may be used without departing from the scope of this disclosure). For each matrix (e.g., matrix shown in FIG. 4A), the intent type for the historical callers is used to segment the callers and a weighted average is taken across various performance indicators of interest. The weights used to calculate the weighted average may be determined by analyzing historical caller data to optimize for performance indicator lift and cost savings. For example, the weights may be identified based on simulations run using a simulation framework shown in FIG. 8. The weights across performance indicators may vary depending on contact channel and/or geography. The APM can extend to other contact channels, geographies, and intent taxonomies. Given a set of training data including historical contacts for a pool of agents, the intent of those contacts and their performance across performance indicators of interest, a new APM can be generated to score and rank that agent population.

The inventors have recognized that in some situations there may not be sufficient data to reliably and accurately estimate the performance of an agent when interacting with callers having a particular intent type. For example, the agent may be a relatively new agent and may not have experience interacting with such callers. As another example, the intent may be relatively uncommon and so few individual agents have substantial experience interacting with such callers. In such situations, where there is not a sufficient number of examples for a particular agent-intent-performance indicator combination, the performance score of the particular agent in handling communication sessions with callers having a particular intent may be estimated in part based on performance scores of other agents handling such communication sessions. To this end, in some embodiments, empirical Bayesian shrinkage may be employed. Bayesian shrinkage uses weighted averages of maximum likelihood estimates, effectively “shrinking” estimates towards an overall population mean, resulting in more stable and less biased estimates. The Bayesian shrinkage model adjusts the presumed historical performance metrics of newer agents to balance out to the mean of the agent pool and gradually adjust to full historical context as the agents gain experience.

Accordingly, in some embodiments, determining, for each of a plurality of agents and for each of a plurality of intents, a plurality of performance scores for a corresponding plurality of performance indicators comprises determining a first performance score for a first performance indicator of a first agent handling communication sessions with callers having a first intent at least in part by: (1) determining a number of communication sessions, handled by the first agent, with callers having the first intent, (2) when the number of communication sessions is greater than a threshold number of communication sessions with callers having the first intent (e.g., in a situation where there is sufficient historical data for the specific combination of first agent and first intent), determining the first performance score based on performance indicator data about the first agent's communication sessions with callers having the first intent, and (3) when it is determined that the first agent has not handled the threshold number of communication sessions with callers having the first intent (e.g., in a situation where there is not sufficient historical data for the specific combination of first agent and first intent), determining the first performance score based on: (i) performance indicator data about the first agent's communication sessions with callers having the first intent (e.g., using the data that is available for the first agent, though these data alone may not be sufficient for a reliable estimate); and (ii) performance indicator data about the communication sessions between one or more other agents with callers having the first intent (e.g., using data available for other agents).

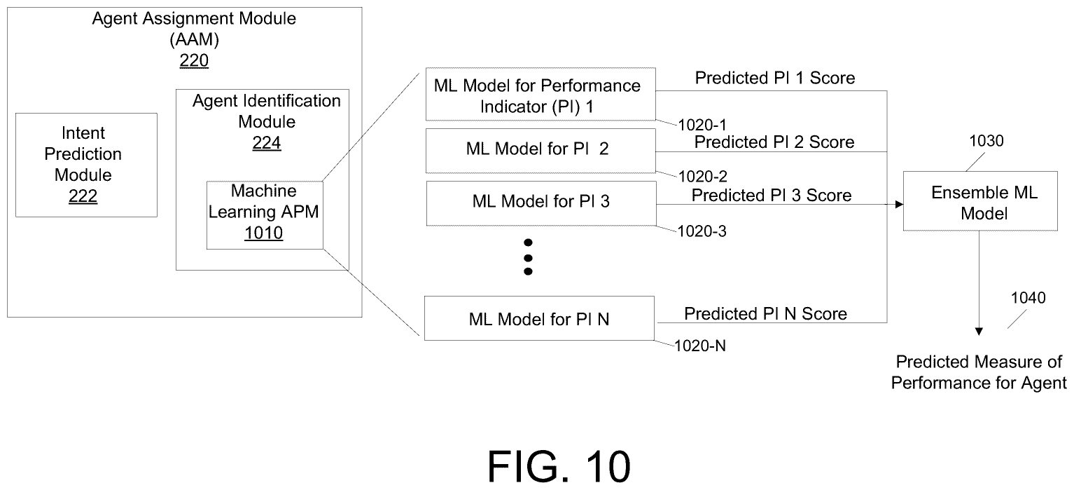

In some embodiments, the two types of performance indicator data (i.e., data about the first agent and data about the one or more other agents) may be combined using Bayesian shrinkage. In some embodiments, this may be done according to the calculations shown in FIG. 10.

Alternatively, in some embodiments, a machine learning (ML) approach may be utilized to identify an agent to assign to the caller. In some such embodiments, the agent identification module 224 includes a machine learning agent performance model (APM) 1010. The APM 1010 is configured to an output a predicted measure of performance for agents using one or more trained machine learning models, as described herein. In turn, the agent identification module 224 identifies, from a plurality of agents 240a, 240b, 240c, an agent (e.g., agent 240c) to assign to the caller by using the identified intent of the caller and the machine learning APM 1010.

In some embodiments, the machine learning APM 1010 may include a set of one or more trained machine learning models 1020-1, 1020-2, 1020-3, . . . , 1020-N, with each of these ML models trained to predict a performance score for a respective performance indicator. Any suitable number of models may be used. For example, the first set of trained ML models may include a trained ML model for each of at least some (e.g., one, some, or all) of the performance indicators listed in Table 3. Other performance indicators may also be used without departing from the scope of this disclosure. For example, customer conversion rate, gross revenue, and/or other performance indicators may be used. Thus, the integer “N” (in reference label 1020-N) may be any suitable integer representing the number of performance indicators for which a performance score is to be predicted. For example, N can be 1, 2, 3, 4, 5, 6, 7, 8, 9, 10, 11, 12, 13, 14, 15, 16, 17, 18, 19, 20, or any integer in the range of 1-500, as aspects of the technology described herein are not limited in this respect.

In the example of FIG. 10, each of the trained ML models 1020-1, 1020-2, 1020-3, . . . 1020-N may be configured to predict, for an agent and with respect to communication sessions with callers having the same intent as the intent of the caller, a performance score for a corresponding performance indicator. For example, the trained machine learning model 1020-1 may predict, for an agent, a performance score for the average handling time (AHT) performance indicator; the trained machine learning model 1020-2 may predict, for an agent, a performance score for the first contact resolution (FCR) performance indicator; the trained machine learning model 1020-3 may predict, for an agent, a performance score for the perfect customer satisfaction (PCSAT) score performance indicator; the trained machine learning model 1020-N may predict, for an agent, a performance score for the low cost resolution (LCR) performance indicator, and so on. Each of these models may be used to predict performance indicators for each of multiple agents, which in turn allows agents to be compared based on their respective predicted performance indicators.

In some embodiments, the ML APM 1010 may include logic for combining the performance scores predicted, for a particular agent, by each of the trained ML models 1020-1, 1020-2, 1020-3, . . . , 1020-N into a single predicted measure of performance for the particular agent. Such logic may be implemented in any suitable way. For example, the logic may be rule based. As another example, the logic may involve machine learning.

For example, in some embodiments, the machine learning APM 1010 may include another machine learning model, shown in FIG. 10 as the ensemble ML model 1030. In some embodiments, a measure of performance, for each particular agent being evaluated, may be determined using the ensemble machine learning model 1030. The ensemble ML model 1030 may be configured to predict a combined performance score using the predicted performance scores obtained from the set of trained ML models 1020-1, 1020-2, 1020-3, . . . , 1020-N. For each particular agent, the predicted performance scores from the set of first trained machine learning models may be provided as inputs to the ensemble machine learning model 1030, which in turn processes these inputs to output a predicted measure for performance 1040 for the particular agent.

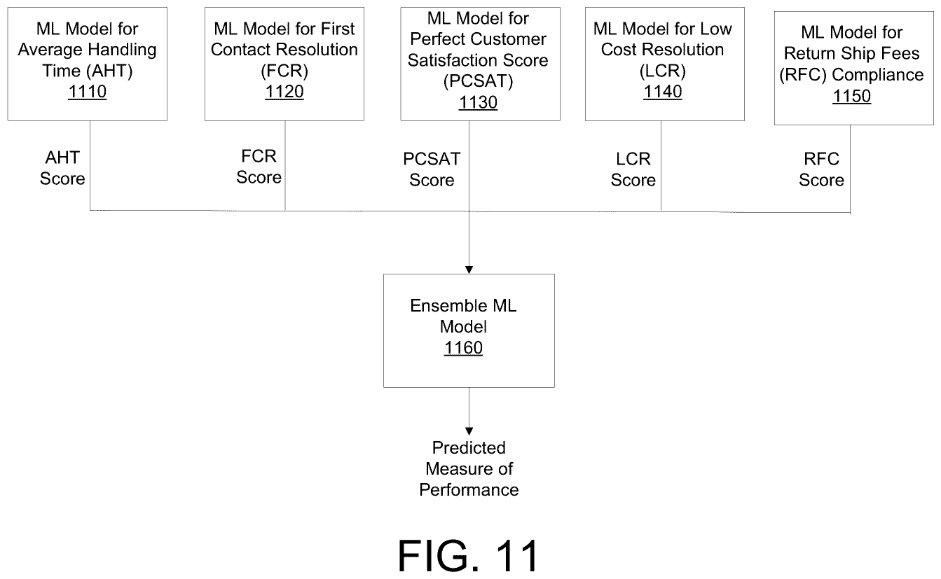

As shown in FIG. 11, the set of first machine learning models may include a machine learning model 1110 that is configured to predict, for each of a plurality of agents, a performance score for the average handling time (AHT) performance indicator; a machine learning model 1120 that is configured to predict, for each of the plurality of agents, a performance score for the first contact resolution (FCR) performance indicator; a machine learning model 1130 that is configured to predict, for each of the plurality of agents, a performance score for the perfect customer satisfaction (PCSAT) score performance indicator; a machine learning model 1140 that is configured to predict, for each of the plurality of agents, a performance score for the low cost resolution (LCR) performance indicator; and a machine learning model 1150 that is configured to predict, for each of the plurality of agents, a performance score for the return ship fees compliance (RFC) performance indicator. For example, for two agents, the machine learning model 1110 may predict a first performance score for the AHT performance indicator for the first agent and a second performance score for the AHT performance indicator for the second agent. Similarly, each of the machine learning models 1120, 1130, 1140, and 1150 may predict first and second performance scores for the corresponding performance indicators for the first and second agents, respectively. In turn, the predicted scores for the two agents may be combined by ensemble ML model 1160 to generate predicted measures of performance for these two agents, which allows the agents to be compared and/or ranked relative to one another. In this way, the predicted measures of performance for the two agents may be used to select one of these two agents for handling an incoming call.

The trained first machine learning models may be configured to predict the performance scores using features (e.g., one, some or all of the features listed below in Table 4) derived from (i) agent data indicating the agents' performance across various caller intents in prior communication sessions with the callers (for example, agents' past performance with respect to the various performance indicators), number of calls handled among the agents' prior to the communication session (also referred to as “occupancy”), and/or other agent data, (ii) caller or customer data (e.g., information about the caller, the issue(s) they are calling about, time of day the communication session was initiated, order information, and/or other caller/customer data), intent information (e.g., intent type identified by the intent prediction model), and/or other data.

In some embodiments, the features derived from agent data and/or caller data may include features selected from the group consisting of at least 1, 2, 3, 4, 5, 6, 7, 8, 9, 10, 11, 12, 13, 14, 15 features selected from the features listed in Table 4. Any suitable number of features may be derived and used by the first trained machine learning models as aspects of the disclosure are not limited in this respect. These derived features may be stored in the database 260.

| Features for ML (AHT) | Feature Description |
|---|---|
| PrecisionQueueName | The name of the specialized business contact queue. |
| | Example: pre-delivery small parcel queue. |
| prob_Report_Problem | Probability the call has identified intent as “Report |
| | Problem”, coming from the Intent Prediction model |
| rate_PCSAT_allagents_PrecisionQueue_past30days | Percentage of successful PCSAT past 30 days for ALL |
| | agent, for the PrecisionQueue of the call |
| rate_FOR_allagents_PrecisionQueue_past30days | Percentage of successful FCR past 30 days for ALL |
| | agent, for the PrecisionQueue of the call |
| rate_veryshort_HT_past30days | Probabilities of call lengths, divided by percentiles 20, |
| | 40, 60, 80, per agent, past 30 days |
| rate_RFC_allagents_PrecisionQueue_past30days | Percentage of successful RFC past 30 days for ALL |
| | agent, for the PrecisionQueue of the call |
| quart1_HT_past30days | 25th percentile of HT for each agent past 30 days |
| prob_Order_Changes | Probability the call has identified intent as “Order |
| | Change”, coming from the Intent Prediction model |
| prob_Cancel | Probability the call has identified intent as |
| | “Cancellation”, coming from the Intent Prediction |
| | model |
| avg_cuHT_past90days | Average contact handle time of this customer over the |
| | trailing 90 days. |
| OrderValue_past7days | Value (in dollars) of all the orders placed past 7 days |
| | by the customer |
| avg_HT_past7days | average HT for each agent past 7 days |
| prob_Assembly | Probability the call has identified intent as “Assembly”, |
| | coming from the Intent Prediction model |
| OrderValue_past30days | Value (in dollars) of all the orders placed past 30 days |
| | by the customer |
| prob_Billing | Probability the call has identified intent as |
| | “Billing/Credit”, coming from the Intent Prediction |
| | model |
| TotQtyOrd_past30days | Quantity of items in all orders placed past 30 days by |
| | the customer |
| median_HT_past30days | median HT for each agent past 30 days |
| TenureDays | Days since the agent was employed |
| TotQtyOrd_past7days | Quantity of items in all orders placed past 7 days by |
| | the customer |
| avg_HT_past30days | average handle time for each agent past 30 days |
| ninetieth_perc_cuHT_past90days | Customer's 90th percentile handle time of Service calls |
| | in the past 90 days |
| incident_rates_rate_rplc_unit | Customers historical incident rate for replacement |
| | units. |
| rate_short_HT_past90days | Rate of this customer's contacts being shorter than 30 |
| | seconds in the trailing 90 days. |
| op_shipped_30to7days_Ih | Whether any items in a customer's order have been |
| | shipped within the last 7 to 30 days |
| prob_Returns | Probability the call has an identified intent as |
| | “Returns”, coming from the Intent Prediction model |
| Features for ML (FCR) | Feature Description |
| order_lifetime_cnt | The total count of orders placed by the customer over |
| | their lifetime with the company. |
| expected_costs_eGIE_30Day | The expected costs associated with the customer |
| | related to gross incidence exposure for the next 30 |
| | days. |
| service_calls_history_cnt | The total number of service calls a customer has made |
| | in their history with the company |
| OrderValue_past7days | Value (in dollars) of all the orders placed past 7 days |
| | by the customer |
| expected_costs_eReturnsGRS_30Day | The expected gross costs associated with product |
| | returns from the customer over the next 30 days. |
| prob_Order_Changes | Probability the call has an identified intent as “Order |
| | Change”, coming from the Intent Prediction model |
| prob_Report_Problem | Probability the call has an identified intent as “Report |
| | Problem”, coming from the Intent Prediction model |
| prob_WIMS | Probability the call has an identified intent as “Where |
| | Is My Stuff”, coming from the Intent Prediction model |
| prob_Cancel | Probability the call has an identified intent as |
| | “Cancellation”, coming from the Intent Prediction |
| | model |
| prob_Billing | Probability the call has an identified intent as |
| | “Billing/Credit”, coming from the Intent Prediction |
| | model |
| TotQtyOrd_past30days | Quantity of items in all orders placed past 30 days by |
| | the customer |
| TotQtyOrd_past7days | Quantity of items in all orders placed past 7 days by |
| | the customer |
| prob_Returns | Probability the call has an identified intent as |
| | “Returns”, coming from the Intent Prediction model |
| prob_Assembly | Probability the call has an identified intent as |
| | “Assembly”, coming from the Intent Prediction model |
| OrderValue_past30days | Value (in dollars) of all the orders placed past 30 days |
| | by the customer |
| op_shipped_30to7days_Ih | Whether any items in a customer's order have been |
| | shipped within the last 7 to 30 days. |
| average_sku_historical_incident_rates_avg_ | The average historical incident rate related to refunds |
| rate_refund | for each SKU ordered by the customer. |
| lifetime_costs_GIE_GRS_ratio_lifetime | The lifetime ratio of Gross Incidence Exposure to |
| | Gross Revenue Stable (GIE to GRS) for the customer. |
| rate_cuFCR_past90days | Rate of times this customer has received a first contact |
| | resolution in the trailing 90 days. |
| multi_item_orders_cnt_7to1days | The count of orders containing multiple items within |
| | the last 1 to 7 days. |
| rate_FCR_past30days | Percentage of successful FCR past 30 days for each |
| | agent |
| Hour | Hour of the day the call started |
| uber_wizard_latest_run_uwlpossessed | Information from the latest run of the uber wizard about |
| | possessed items. |
| incident_rates_rate_return | A customer's historical return rate. |
| TenureDays | Days since the agent was employed |
| Features for ML (PCSAT) | Feature Description |
| skewness_PCSAT_past90days | Skewness of PCSAT performance past 90 days for |
| | each agent |
| prob_WIMS | Probability the call has identified intent as “Where Is |
| | My Stuff”, coming from the Intent Prediction model |
| rate_PCSAT_WIMS_past90days | Rate of perfect customer satisfaction on where is my |
| | stuff contacts in the trailing 90 days. |
| mode_HT_past7days | mode of handle time for each agent past 7 days |
| mode_HT_past30days | mode of handle time for each agent past 30 days |
| rate_PCSAT_past90days | Percentage of successful PCSAT past 90 days for |
| | each agent |
| avg_HT_NonAPM_past30days | average handle time for each agent handling “Non- |
| | APM” wrap calls past 30 days |
| rate_LCR_PrecisionQueue_past90days | Percentage of successful LCR past 90 days for each |
| | agent, for the PrecisionQueue of the call |
| mode_HT_past90days | mode of handle time for each agent past 90 days |
| rate_RFC_allagents_PrecisionQueue_past30days | Percentage of successful RFC past 30 days for ALL |
| | agent, for the PrecisionQueue of the call |
| std_PCSAT_past90days | Standard Deviation of PCSAT performance past 90 |
| | days for each agent |
| rate_PCSAT_WIMS_past30days | Rate of perfect customer satisfaction on where is my |
| | stuff contacts in the trailing 30 days. |
| WaitTimeInQueue | How many seconds the customer was waiting in the |
| | queue |
| rate_PCSAT_ReportProblem_past90days | Rate of perfect customer satisfaction on report a |
| | problem contacts in the trailing 90 days. |
| agent_call_count_in_day | The number of sessions answered by each agent that |
| | day |
| lifetime_costs_GIE_GRS_ratio_lifetime | The lifetime ratio of Gross Incidence Exposure to |
| | Gross Revenue Stable (GIE to GRS) for the customer. |
| std_LCR_past90days | Standard Deviation of LCR performance past 90 days |
| | for each agent |
| prob_Report_Problem | Probability the call has an identified intent as “Report |
| | Problem”, coming from the Intent Prediction model |
| rate_PCSAT_Cancel_past90days | Rate that customers have had perfect customer |
| | satisfaction scores on cancellations contacts in the |
| | trailing 90 days. |
| rate_PCSAT_Returns_past90days | Rate that customers have had perfect customer |
| | satisfaction scores on returns contacts in the trailing 90 |
| | days. |
| rate_PCSAT_ReportProblem_past30days | Rate that customers have had perfect customer |
| | satisfaction scores on report a problem contacts in the |
| | trailing 30 days. |
| rate_PCSAT_PrecisionQueue_past90days | Percentage of successful PCSAT past 90 days for |
| | each agent, for the PrecisionQueue of the call |
| total_Billing_calls_past90days | Number of “Billing/Credit” wrap calls handled past 90 |
| | days |
| op_shipped_30to7days_Ih | Whether any items in a customer's order have been |
| | shipped within the last 7 to 30 days. |
| avg_HT_PreQueueSmPPost_past7days | Average overall small parcel pre delivery queue handle |
| | time in the trailing 7 days. |
| Features for ML (LCR) | Feature Description |
| average_sku_historical_incident_rates_avg_ | The average historical incident rate for replacement |
| rate_rplc_part | parts for |
| | each SKU ordered by the customer. |
| TotQtyOrd_past30days | Quantity of items in all orders placed past 30 days by |
| | the customer |
| average_sku_historical_incident_rates_max_rate | The maximum historical incident rate per replacement |
| rplc_part | part for each SKU ordered by the customer. |
| rate_LCR_past90days | Percentage of successful LCR past 90 days for each |
| | agent |
| average_sku_historical_incident_rates_avg_ | The average historical incident rate for replacement |
| rate_rplc_unit | unit for each SKU ordered by the customer. |
| TotQtyOrd_past7days | Quantity of items in all orders placed past 7 days by |
| | the customer |
| prob_Returns | Probability the call has an identified intent as |
| | “Returns”, coming from the Intent Prediction model |
| prob_Assembly | Probability the call has an identified intent as |
| | “Assembly”, coming from the Intent Prediction model |
| average_sku_historical_incident_rates_avg_ | Average historical rate of return for SKUs ordered by |
| rate_return | the customer |
| expected_costs_eGIE_30Day | The expected costs associated with the customer |
| | related to gross incidence exposure for the next 30 |
| | days |
| PredictedWrap | Predicted WRAP, coming from Intent Prediction model |
| OrderValue_past7days | Value (in dollars) of all the orders placed past 7 days |
| | by the customer |
| prob_WIMS | Probability the call has an identified intent as “WIMS”, |
| | coming from the Intent Prediction model |
| prob_Billing | Probability the call has an identified intent as |
| | “Billing/Credit”, coming from the Intent Prediction |
| | model |
| average_sku_historical_incident_rates_avg_ | The average historical incident rate related to refunds |
| rate_refund | for each SKU ordered by the customer. |
| expected_costs_eReturnsGRS_30Day | The expected gross costs associated with product |
| | returns from the customer over the next 30 days. |
| std_LCR_past90days | Standard Deviation of LCR performance past 90 days |
| | for each agent |
| OrderValue_past30days | Value (in dollars) of all the orders placed past 30 days |
| | by the customer |
| prob_Report_Problem | Probability the call has an identified intent as “Report |
| | Problem”, coming from the Intent Prediction model |
| multi_item_orders_cnt_30to7days | The count of orders containing multiple items within |
| | the last 7 to 30 days. |
| average_sku_historical_incident_rates_max_rate | The highest historical incident rate related to discount- |
| dtk | to-keep (DTK) for each SKUordered by the customer. |
| incident_rates_rate_rplc_unit | Customers historical incident rate for replacement |
| | units. |
| average_sku_historical_incident_rates_max_rate | The maximum historical incident rate for replacement |
| rplc_unit | units for each SKU ordered by the customer. |
| service_calls_history_cnt | The total number of service calls a customer has made |
| | in their history with the company. |
| rate_LCR_allagents_PrecisionQueue_past30days | Percentage of successful LCR past 30 days for ALL |
| | agent, for the PrecisionQueue of the call |
| Features for ML (RFC) | Feature Description |
| std_RFC_past90days | Standard Deviation of RFC performance past 90 days |
| | for each agent |
| rate_RFC_past90days | Percentage of successful RFC past 90 days for each |
| | agent |
| rate_RFC_past30days | Percentage of successful RFC past 30 days for each |
| | agent |
| skewness_RFC_past90days | Skewness of RFC performance past 90 days for each |
| | agent |
| average_sku_historical_incident_rates_max_ | The highest historical incident rate related to returns |
| rate_return | for each SKU ordered by the customer. |
| prob_Returns | Probability the call has an identified intent as |
| | “Returns”, coming from the Intent Prediction model |
| std_RFC_past30days | Standard Deviation of RFC performance past 30 days |
| | for each agent |
| uber_wizard_latest_run_uwlpossessed | Information from the latest run of the uber wizard about |
| | possessed items. |
| skewness_RFC_past30days | Skewness of RFC performance past 30 days for each |
| | agent |
| expected_costs_eGIE_30Day | The expected costs associated with the customer |
| | related to gross incidence exposure for the next 30 |
| | days. |
| average_sku_historical_incident_rates_avg_ | The average historical incident rate for each SKU |
| rate_inc | ordered by the customer. |
| incident_rates_rate_return | A customer's historical return rate. |
| PredictedWrap | Predicted WRAP, coming from Intent Prediction model |
| total_NonAPM_calls_past90days | Number of “Non-APM wrap” calls handled past 90 |
| | days |
| prob_Order_Changes | Probability the call has an identified intent as “Order |
| | Changes”, coming from the Intent Prediction model |
| incident_rates_rate_inc | The rate of incidents, such as issues with orders or |
| | customer service, for the customer. |
| rate_LCR_past30days | Percentage of successful LCR past 30 days for each |
| | agent |
| prob_WIMS | Probability the call has an identified intent as “Where is |
| | my stuff?” (WIMS), coming from the Intent Prediction |
| | model |
| MinBeforeLastLogoff | Number of minutes customer was logged in to their |
| | last verified browsing session. |
| average_sku_historical_incident_rates_avg_ | Average historical rate of return for SKUs ordered by |
| rate_return | the customer. |
| rate_RFC_PrecisionQueue_past90days | Percentage of successful RFC past 90 days for each |
| | agent, for the PrecisionQueue of the call |
| op_shipped_30to7days_Ih | Whether any items in a customer's order have been |
| | shipped within the last 7 to 30 days. |
| PrecisionQueueName | The name of the specialized business contact queue. |
| | Example: pre-delivery small parcel queue. |
| std_RFC_past7days | Standard Deviation of RFC performance past 7 days |
| | for each agent |
| rate_RFC_past7days | Percentage of successful RFC past 7 days for each |
| | agent |

In some embodiments, each of the first trained machine learning models 1110, 1120, 1130, 1140, 1150 may comprise a gradient-boosted decision tree model. The gradient-boosted decision tree model may be an ensemble of multiple decision trees (e.g., between 100-1000 decision trees, between 500-1000 decision trees, between 250-750 decision trees, or any other suitable range within these ranges). The prediction (e.g., classification) generated by the gradient-boosted decision tree model is formed based on the predictions generated by the multiple decision trees part of the ensemble. The ensemble may be trained using an iterative optimization technique involving calculation of gradients of a loss function (hence the name “gradient” boosting). Any suitable supervised training algorithm may be applied to train a gradient-boosted decision tree model including, for example, any of the algorithms described in Hastie, T.; Tibshirani, R.; Friedman, J. H. (2009). “10. Boosting and Additive Trees”. The Elements of Statistical Learning (2nd ed.). New York: Springer. pp. 337-384. In some embodiments, the gradient-boosted decision tree model may be implemented using any suitable publicly available gradient boosting framework such as XGBoost (e.g., as described, for example, in Chen, T., & Guestrin, C. (2016). XGBoost: A Scalable Tree Boosting System. In Proceedings of the 22nd ACM SIGKDD International Conference on Knowledge Discovery and Data Mining (pp. 785-794). New York, NY, USA: ACM.). The XGBoost software may be obtained from http://xgboost.ai, for example). Another example framework that may be employed is LightGBM (e.g., as described, for example, in Ke, G., Meng, Q., Finley, T., Wang, T., Chen, W., Ma, W., . . . Liu, T.-Y. (2017). Lightgbm: A highly efficient gradient boosting decision tree. Advances in Neural Information Processing Systems, 30, 3146-3154.). The LightGBM software may be obtained from https://lightgbm.readthedocs.io/, for example). Yet another example framework that may be employed is CatBoost (e.g., as described, for example, in Prokhorenkova et al., “CatBoost: unbiased boosting with categorical features,” Machine Learning, arXiv:1706.09516, January 2019 and Dorogush et al., “CatBoost: gradient boosting with categorical features support,” Machine Learning, arXiv:1810.11363, October 2018). These articles are incorporated by reference herein in their entirety.

In some embodiments, a neural network classifier may be used. The neural network classifier may be trained using any suitable neural network optimization software. The optimization software may be configured to perform neural network training by gradient descent, stochastic gradient descent, or in any other suitable way. In some embodiments, the Adam optimizer (Kingma, D. and Ba, J. (2015) Adam: A Method for Stochastic Optimization. Proceedings of the 3rd International Conference on Learning Representations (ICLR 2015)) may be used. This article is incorporated by reference herein in its entirety.

In some embodiments, a recurrent neural network (e.g., a long short-term memory (LSTM) neural network) may be used. In some embodiments, a neural network having a transformer based architecture may be used.

As shown in FIG. 11, each agent's predicted performance score for each performance indicator is provided as input to the ensemble machine learning model 1160. For example, a first agent's predicted performance score for the AHT performance indicator (from model 1110), the FCR performance indicator (from model 1120); the PCSAT performance indicator (from model 1130); the LCR performance indicator (from model 1140); and the RFC performance indicator (from model 1150), may be provided as input to the ensemble machine learning model 1160. The various performance scores for each agent may be similarly provided from the first machine learning models 1110, 1120, 1130, 1140, 1150 to the ensemble machine learning model 1160.

In some embodiments, for each particular agent of the at least some of the plurality of agents, a measure of performance of the particular agent may be determined using the ensemble trained machine learning model 1160 configured to predict a combined performance score using the performance scores obtained from the first trained machine learning models. For example, the ensemble trained machine learning model 116 may predict a combined performance score for Agent 1 using the agent 1's predicted performance score for the AHT performance indicator (from model 1110), the FCR performance indicator (from model 1120); the PCSAT performance indicator (from model 1130); the LCR performance indicator (from model 1140), and the RFC performance indicator (from model 1150).

In some embodiments, the ensemble trained machine learning model may comprise a gradient-boosted decision tree model as described herein.

In some embodiments, identifying the agent to assign to the caller using the identified intent of the caller and the machine learning APM, comprises determining, for each particular agent of the at least some of the plurality of agents, a measure of performance of the particular agent using the ensemble trained machine learning model, thereby obtaining a plurality of measures of performance, and ranking the at least some of the plurality of agents using the plurality of measures of performance. In some embodiments, the measure of performance is the combined performance score predicted by the ensemble trained machine learning model.

In some embodiments, the ensemble trained machine learning model may provide a ranked list of agents based on their measure of performance for the same intent as the identified intent.

In some embodiments, ranking the at least some of the plurality of agents using the plurality of measures of performance comprises ranking available agents (i.e., agents who are available and can be assigned to the caller in the communication session) using their respective measures of performance. In some embodiments, identifying an agent to assign to the caller in the communication session by using the identified intent of the caller and the machine learning APM comprises identifying, from the ranked available agents, an agent with the highest measure of performance for the identified intent relative to the measures of performance for the other agents.

In some embodiments, the machine learning APM 1010 accepts as input the identified intent of the caller in the communication session and outputs a ranked list of agents based on their measure of performance for the same intent as the identified intent. In cases where an intent may not be available, an intent agnostic ranking may be returned. In some embodiments, a top ranked agent may be identified to assign to the caller. The top ranked agent may be an agent having the highest measure of performance for the identified intent of the caller.

Referring back to FIG. 2A, the agent identification module 224 assigns the identified agent to the caller and the routing interface 230 routes the caller to the identified agent. In some embodiments, the routing interface 230 may be part of a telephony or software-based system used in the contact center 200 for handling communication sessions with callers, such as a system provided by Cisco, Genesys, and/or other communication solution providers for contact centers. For example, as shown in FIG. 2B, a voice call between caller 201 and the communication management system 240 may be initiated. The voice call may be handled via IVR 212. The agent assignment module 220 may (1) identify an intent of the caller using caller data and the first trained ML model configured to predict intent of callers, (2) identify, from a plurality of agents, an agent to assign to the caller in the communication session by using the identified intent of the caller and an APM configured to rank at least some of the plurality of agents based on a measure of their performance in communication sessions with callers having a same intent as the intent of the caller, and (3) assign the identified agent to the caller. The routing interface 230 may route the caller 201 to the identified agent, such as agent 240c as shown by the dashed line in FIG. 2B.

In some embodiments, assignment of the agents to callers may be performed to account for occupancy unfairness where certain agents handle more calls than other agents. Occupancy unfairness may be mitigated, for example, by delaying calls to over-occupied agents so that the calls are more equally distributed among the agents. In some embodiments, multiple agent performance models may be used for agents distributed in different geographic locations, for example, a first agent performance model may be used for on-shore agents and a second agent performance model may be used for off-shore agents.

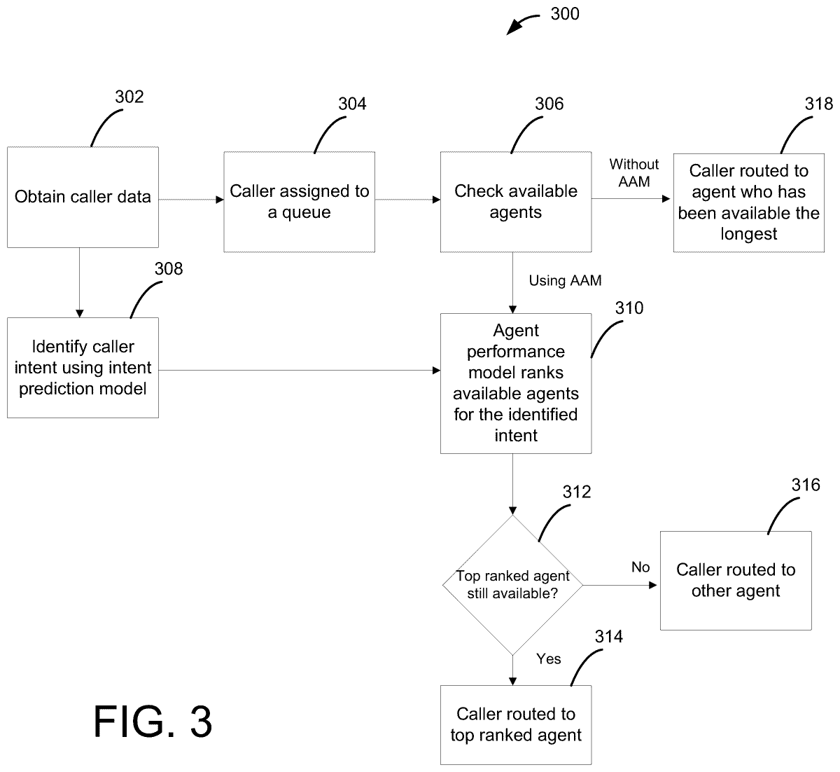

FIG. 3 illustrates a diagram 300 of an example flow of acts performed by the communication management system 250 shown in FIGS. 2A-2B, according to some embodiments of the technology described herein. In some embodiments, at act 302, the communication management system 250 may initiate a communication with a caller and obtain caller data. In some embodiments, obtaining the caller data may include obtaining statement(s) from the caller in the communication session, via the chat interface 214, for example. In some embodiments, obtaining the caller data may include obtaining voice input from the caller in the communication session, via the IVR 212, for example. In some embodiments, obtaining the caller data may include obtaining data about the caller's historical behavior from the database 260.

At act 304, the caller may be assigned to a queue. The queue may be a virtual queue in which callers are placed when contacting the contact center 202. Callers in the virtual queue are placed on hold until an agent is identified who can assist them. In some embodiments, act 304 may be performed for scenarios where the AAM 220 is not used for handling callers' communication sessions. As such, act 304 may be optional and the communication management system 250 may perform acts 306, 308, 310, 312, 314, 316 described herein regardless of whether a queue is used.

At act 306, a check is made for available agents who can handle the communication session. When the AAM 220 is used to identify an agent to assign to the caller, acts 308 and 310 are performed. At act 308, an intent of the caller is identified by using the caller data and the first trained ML model configured to predict intent of callers. At act 310, an agent to assign to the caller in the communication session is identified by using the identified intent of the caller and the APM configured to rank at least some of a plurality of agents (e.g., available agents) based on a measure of their performance in communication sessions with callers having a same intent as the identified intent of the caller. In some embodiments, a top ranked agent may be identified to assign to the caller. The top ranked agent may be an agent having the highest measure of performance for the identified intent of the caller.

At act 312, a determination may be made whether the top ranked agent is still available to handle the communication session between the caller and the communication management system. In response to a determination that the top ranked agent is available to handle the communication session, the caller may be routed to the top ranked agent, in act 314. In response to a determination that the top ranked agent is unavailable to handle the communication session, the caller, at act 316, may be routed to another agent. In some embodiments, the other agent may be an agent with lower measure of performance for the identified intent relative to the top ranked agent but who is available to handle the communication session. In some embodiments, the other agent may be an agent who has been available the longest with or without consideration of the agent's measure of performance for the identified intent.

In some embodiments, when the AAM 220 is not used to identify an agent to assign to the caller, the caller, at act 318, may be routed an agent who has been available the longest.

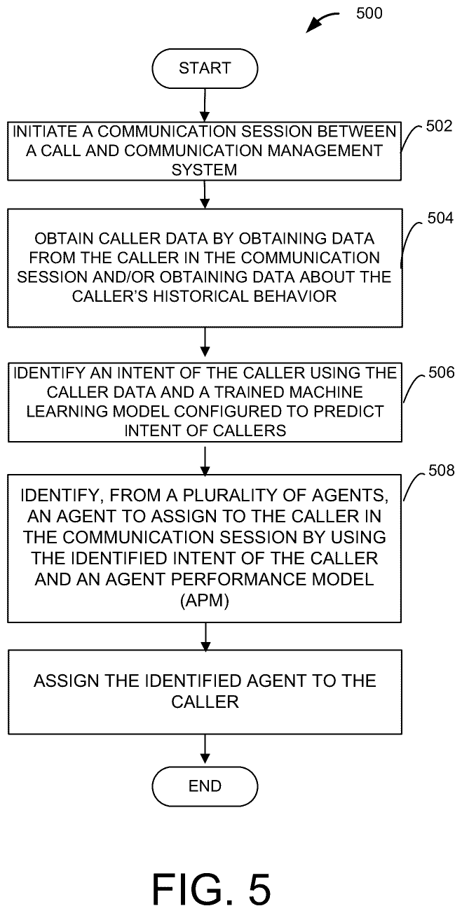

FIG. 5 is a flowchart of an example process for assigning agents to callers that have contacted a contact center using the system shown in FIGS. 2A-2B, according to some embodiments of the technology described herein. Process 500 may be performed by any suitable computing device or system. For example, process 500 may be performed by the communication management system 250 described above with reference to FIGS. 2A-2B.

Process 500 begins at block 502, where the system performing process 500 initiates a communication session between a caller (e.g., caller 201) and the communication management system 250. In some embodiments, initiating the communication session is performed by an IVR 212 part of the communication management system 250, for example, by receiving a voice call from the caller 201. In some embodiments, initiating the communication session is performed by chat interface 214 part of the communication management system 250, for example, by initiating a chat between the caller 201 and the communication management system 250. In some embodiments, initiating the communication session is performed by a virtual assistant interacting with the caller via a software application. In some embodiments, the software application may include a retailer's mobile app installed on the caller's device.

At block 504, the system performing process 500 obtains caller data by obtaining data from the caller in the communication session and/or obtaining data about the caller's historical behavior. In some embodiments, the caller data may be obtained from the caller itself while interacting with the IVR 212 (e.g., as key or voice input), chat interface 214 (e.g., as textual input), and/or other communication interface, such as the virtual assistant (e.g., as voice input). In some embodiments, the caller data including data about the caller's historical behavior may be obtained from database 260.

At block 506, the system performing process 500 identifies an intent of the caller 201 by using the caller data and a trained ML model (e.g., the first trained ML model described herein) configured to predict intent of callers.

At block 508, the system performing process 500 identifies an agent to assign to the caller 201 in the communication session. In some embodiments, identifying an agent to assign to the caller 201 is performed using the identified intent of the caller 201 and an APM configured to rank at least some of a plurality of agents based on a measure of their performance in communication sessions with callers having a same intent as the intent of the caller. For example, the contact center may employ 2000 agents. When the communication session between the caller and the communication management system is initiated, only some of the agents may be available to handle the communication session with the caller as other agents may be assisting other callers. The APM may determine, for each available agent, a measure of performance in previous communication sessions with callers having the same intent as the identified intent of the caller 201. For example, if ten agents are available and the identified intent is “Intent 4”, a measure of performance may be determined for each of the ten agents, the measure of performance indicating a respective agent's performance in previous communication sessions with callers having “Intent 4”. The APM may rank these agents based on the measure of their performance such that an agent having the highest measure of performance for the identified intent is identified as the agent to be assigned to the caller 201.

At block 510, the system performing process 500 assigns the identified agent (e.g., agent 240c) to the caller 201 and the caller 201 is routed to the identified agent via the routing interface 230.

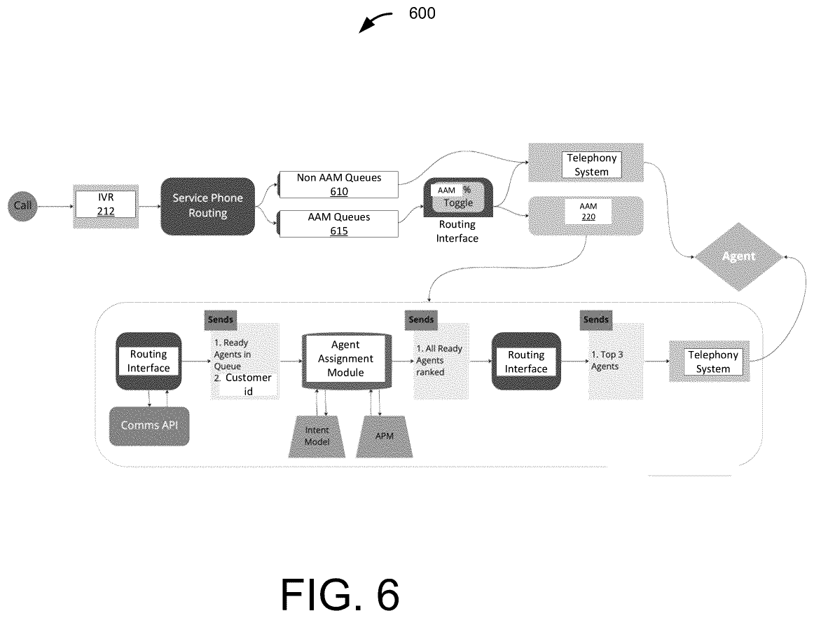

FIG. 6 is block diagram 600 illustrating an example implementation of the system shown in FIGS. 2A-2B, where a communication session between a caller and the system is initiated by receiving a voice call from the caller, according to some embodiments of the technology described herein. As shown in FIG. 6, a communication session between a caller and the system may be initiated and the caller may be assigned to a queue. In some embodiments, the system may include a first queue 615 in which callers whose sessions are to be handled using the AAM 220 are placed and a second queue 610 in which callers whose sessions are to be handled without using the AAM 220 are placed. A determination of whether to place the caller in the first queue or the second queue may be made based on various criteria, such as, whether historical data about the caller exists, whether input obtained from the caller can be used by the AAM 220, and/or other criteria. In some embodiments, a caller from the second queue 610 may be routed to an agent who is identified without using the AAM 220. In some embodiments, a caller from the first queue 615 may be routed to an agent who is identified using the AAM 220. In some embodiments, a threshold number of callers (e.g., 5, 10, 20, 25 or any other suitable threshold) from the first queue 615 may be routed to the AAM 220. In some embodiments, for callers routed to the AAM 220, the intent prediction module 222 identifies an intent of the callers and the agent identification module 224 identifies agents to assign to the callers as described herein.

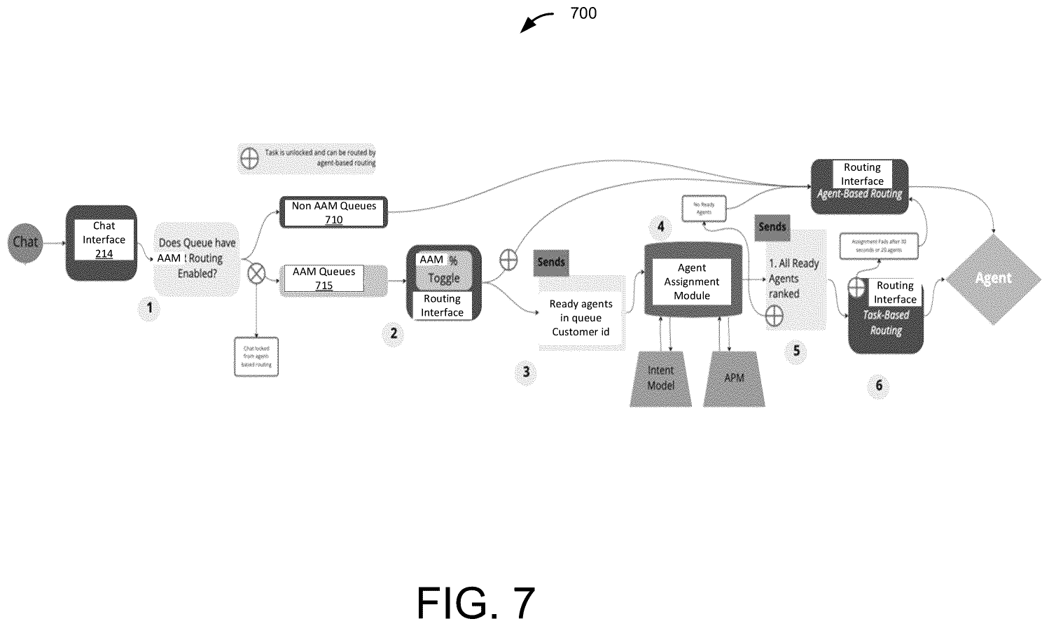

FIG. 7 is block diagram illustrating an example implementation of the system shown in FIGS. 2A-2B, where a communication session between a caller and the system is initiated by initiating a chat between a caller and the system, according to some embodiments of the technology described herein. As shown in FIG. 7, a communication session between a caller and the system may be initiated and a determination may be made regarding whether AAM-based routing of callers to agents is enabled for a queue. In some embodiments, the system may include a first queue 715 in which callers whose sessions are to be handled using the AAM 220 are placed and a second queue 710 in which callers whose sessions are to be handled without using the AAM 220 are placed. A determination of whether to place the caller in the first queue or the second queue may be made based on various criteria, such as, whether AAM-based routing is enabled, whether historical data about the caller exists, whether input obtained from the caller can be used by the AAM 220, and/or other criteria. In some embodiments, a caller may be placed in the first queue 715 when a determination is made that AAM-based routing for the first queue is enabled and a caller may be placed in the second queue 710 when a determination is made that AAM-based routing for the second queue is not enabled. In some embodiments, a caller from the second queue 710 may be routed to an agent who is identified without using the AAM 220. In some embodiments, a caller from the first queue 715 may be routed to an agent who is identified using the AAM 220. In some embodiments, a threshold number of callers (e.g., 5, 10, 20, 25 or any other suitable threshold) from the first queue 715 may be routed to the AAM 220. In some embodiments, for callers routed to the AAM 220, the intent prediction module 222 identifies an intent of the callers and the agent identification module 224 identifies agents to assign to the callers as described herein.

FIG. 8 is an example simulator framework 800 used for determining weights used in an agent performance model, according to some embodiments of the technology described herein. In some embodiments, the simulator framework 800 was built to understand the expected impact of various routing algorithms/policies on various sets of contact center performance indicators. A retailer may have service level expectations for callers like handling X % of callers handles within Y seconds, and agent utilization standards/benchmarks. In addition, it is beneficial to ensure equitable caller distribution as it has an impact on agent performance/compensation.

In some embodiments, inputs to the simulator framework may include, but not be limited to, distributions of caller arrivals/start times (by hour), caller intent frequencies, intent prediction recall, caller handle times by intent, agent schedules, distribution of logged in and ready agent status (by hour), historical agent performance scores by intent, and fraction of calls routed via AAM (aam_frac).

In some embodiments, the simulator framework implementation works with events stored and sorted in a heapq data structure or any other suitable data structure. The simulation traverses temporally through the heapq data structure, popping each next event, and applying the following logic:

Keep track of 2 sets: L: logged in agents; R: ready agents

| | |
|---|---|
| 1. | Pre-populate heapq with events: “call-start”, “agent-log-in”, |
| | “agent-log-out” |
| 2. | Loop through popping earliest event from heapq: |
| | IF event == “call-start”: |

| | |
|---|---|
| ∘ | Randomly decide if to route via AAM or random |

(first-in-first- out) routing at the rate of aam_frac

| ∘ | Assign an available agent: |
|---|---|
| | If AAM routing, sample a predicted intent of the |
| caller using the intent prediction confusion matrix, and | |
| route based on APM scores in that intent; | |
| | If Random routing, assign to longest idle available |
| | agent; |
| ∘ | Remove the agent from set R |
| ∘ | Sample handle time based on the agent's average |

and standard deviation of handle times in the caller's predicted
intent

| | |
|---|---|
| ∘ | Add new event “call-end” to heapq at the end time |

| based on the sampled handle time | |
|---|---|
| ∘ | Sample and record outcome performance indicators based |

on the agent's stats in the caller's predicted intent
ELIF event == “call-end”:

| | |
|---|---|
| ∘ | IF agent is in set L (still logged-in), add agent to set |
| | R |
| ∘ | IF agent is not in L, he or she was handling a session |

that went over log-off time, so there is nothing to do (i.e., do not
add agent to R)
ELIF event == “agent-log-off”:

| | |
|---|---|
| ∘ | Remove agent from L and R |

ELIF event == “agent-log-in”:

| | |
|---|---|
| ∘ | Add agent to L and R |

The simulation stops when the heapq becomes empty.

In some embodiments, the average performance indicators of each such simulation run from the recorded lists of each routing type (e.g., Random, AAM) are calculated. Performance indicator lifts between AAM and Random routing are calculated. The simulation is repeated for many runs, in which the sampling varies, and then the medians and confidence intervals of the average performance indicators and performance indicator lifts from the outputs (from all the runs) may be calculated.

The inventors have recognized that such a robust simulation framework allows for experimentation with and testing new routing algorithms before deploying them in production allowing for more effective A|B testing; estimation of the outcomes and risks of scaling a routing algorithm to full scale before actually scaling it; experimentation with features of a routing algorithm, such as adding a mechanism to up-skill lower performing agents; choosing algorithms/parameters, weights, etc. that optimize the performance indicators while avoiding undesirable scenarios, like some agents not receiving any contacts; running a search over a routing algorithm's parameters to find the optimal ones (like hyper-parameter tuning), and simulating how a routing system would behave in extreme conditions, like high occupancy.

### Example Use Case

As described herein, the communication management system 250 connects callers with the best agent for their individual needs by leveraging historical caller data and agent performance data. Provided below is an example scenario of a caller calling the contact center 202 because of missing hardware for a purchased product.

The caller purchased a platform bed and calls the contact center as the platform bed arrived, but the hardware is missing. Caller data may be obtained, such as, caller information (e.g., caller loyalty status, style preference (e.g., AllModern and Wayfair), etc.), purchase or order history (e.g., a number of products purchased within a particular time frame, such as 3 products in the last 6 months, product types purchased and purchase dates), delivery status (e.g., whether purchased products were delivered and when), recent browsing behavior (e.g., views or clicks while browsing the online shopping platform, such as clicks to a “Report Issue” page). The caller data associated with the caller reveals that the caller purchased a queen platform bed that was delivered 2 days ago. Product history information about the platform bed reveals that this bed has frequent contacts about missing parts issues.

The intent prediction module 222 utilizes the caller data and/or product history information to identify an intent of the caller. In this example, the identified intent is “Product Issue”. Once the intent of the caller is identified, the agent identification module 224 utilizes the APM to connect the caller with the best available agent for the identified intent. The identified agent has high scores for the “Product Issue” intent, based on the last 10 months of her employee data. The identified agent is able to efficiently handle the caller's concern and explain where to find the missing parts for the platform bed, resulting in improved customer experience.

### Other Implementation Details

In some implementations, the communication management system may use a change data capture (CDC) strategy combined with Vertex Pipelines to precompute a set of features, with up to 15-minute freshness, to allow a real time inference engine hosted on Vertex Endpoints low latency access to features with less than one second response times. The CDC strategy ensures that the features (e.g., features included in Table 2) are up to date by capturing changes to the underlying data sources and applying them to a feature store for later real time querying. This enables the system to provide customers with the most accurate and timely information possible. It also minimizes incurred costs based on the 97% smaller amount of data stored. Vertex Pipelines is a fully managed service that makes it easy to create, schedule, and monitor data pipelines. Vertex Pipelines is used to precompute the features on a regular schedule, which ensures that they are always available when customers need them, down to a freshness of 15 minutes. A real time inference engine is hosted on Vertex Endpoints, which is a fully managed service that makes it easy to deploy and manage machine learning models. Vertex Endpoints is used to provide the communication management system with low latency access to candidate intent scores, which allows it to make real-time APM lookups based on the latest data.

The Vertex Pipeline retraining job for the APM retrains the APM daily to ensure that the output skill scores of each agent are up to date. This is beneficial because when new hire agents come onboard, their skills deviate from the average assigned to them by Bayesian Shrinkage within 30 to 50 contacts in a single intent type. The retraining job uses the latest data from the contact center to update the APM, which in turn provides more accurate skill scores for agents. This helps agents to be more effective in their roles and provides managers with better insights into agent performance.

A model controller hosts access to underlying machine learning models in a modular way. First, the model controller allows for hot-swapping model versions without disrupting service. This enables quick deployment of new models that have been trained on more recent data or that have been improved through additional research. Second, the model controller allows for changing the splits of traffic for A/B tests in one line of code. This makes it easy to experiment with different model configurations and to find the one that provides the best results. Finally, it acts as a single unified service layer for the retailer's customer service ML product portfolio. This makes it easier to manage and monitor the ML models, and to share models and data between different teams. Overall, having a model controller host access to underlying machine learning models in a modular way provides a cost efficiency and product effectiveness in all ML operations.

A ML observability platform, such as, Arize can be used to monitor model prediction drift and feature drift. Arize is a cloud-based platform that provides real-time monitoring of machine learning models. It can detect changes in model performance, such as changes in accuracy or bias, and can also detect changes in the data that the model is trained on. This information can be used to identify potential problems with the model and to take corrective action. A web-based data visualization tool, such as Google Studio dashboards, can be used for continuous business impact monitoring of the impacted performance indicators. Google Studio is a data visualization and reporting tool that allows creation of dashboards that show the performance of the business. These dashboards are used to track performance indicators such as revenue, website traffic, and customer satisfaction. The dashboards can also be used to identify trends and to spot potential problems. A cloud-based monitoring platform, such as DataDog, is used for monitoring telemetry and health of the systems and pipelines. DataDog provides real-time visibility into system performance and pipelines. It collects data from a variety of sources, including servers, applications, and databases. This data is used to track the systems' performance, to identify potential problems, and to alert the teams to take corrective action.

A twofold A/B testing strategy can be used. First, the routing interface may segment caller by phone number hash between a control group (non-AAM callers) and a test group (AAM callers). This ensures that each group is statistically representative of the overall population of callers. Second, the model controller has a dynamic traffic split allocator for testing two or more parallel intent models. This allows testing of different models and configurations in parallel, and to quickly identify the most effective model for each call type. This strategy allows testing of new features and improvements quickly and efficiently, and to ensure that the most effective models are used to route calls.

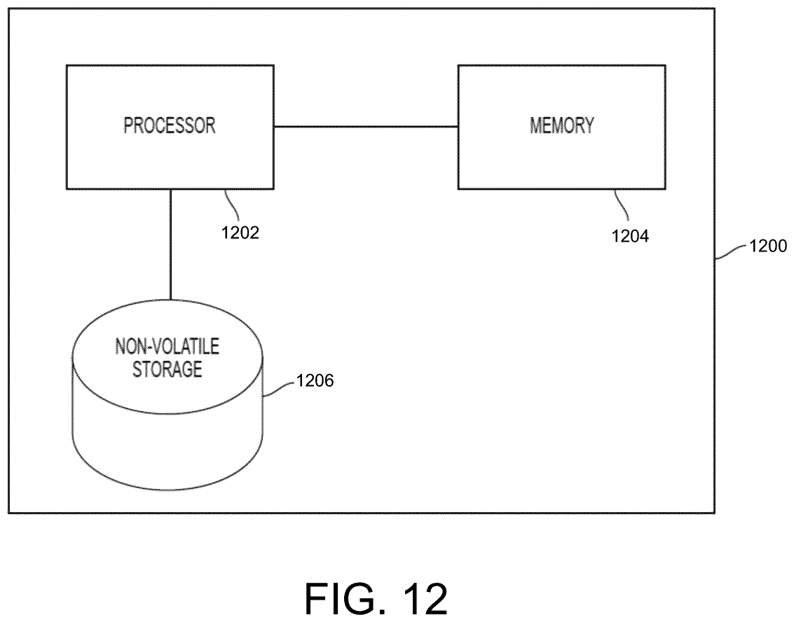

FIG. 12 shows a block diagram of an example computer system 1200 that may be used to implement embodiments of the technology described herein. The computing device 1200 may include one or more computer hardware processors 1202 and non-transitory computer-readable storage media (e.g., memory 1204 and one or more non-volatile storage devices 1206). The processor(s) 1202 may control writing data to and reading data from (1) the memory 1204; and (2) the non-volatile storage device(s) 1206. To perform any of the functionality described herein, the processor(s) 1202 may execute one or more processor-executable instructions stored in one or more non-transitory computer-readable storage media (e.g., the memory 1204), which may serve as non-transitory computer-readable storage media storing processor-executable instructions for execution by the processor(s) 1202.

The computer system 1200 may be a portable computing device (e.g., a smartphone, a tablet computer, a laptop, or any other mobile device), a computer (e.g., a desktop, a rack-mounted computer, a server, etc.), or any other type of computing device.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method for assigning agents to callers that have contacted a contact center by using a communication management system for the contact center, the method comprising:
using at least one computer hardware processor to perform:
initiating a communication session between a caller and the communication management system;
obtaining caller data by obtaining data from the caller in the communication session and/or obtaining data about the caller's historical behavior;
identifying an intent of the caller by using the caller data and a trained machine learning (ML) model configured to predict intent of callers;
identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and
assigning the identified agent to the caller.

2. The method of claim 1, wherein initiating the communication session between the caller and the communication management system comprises receiving a voice call from the caller by the communication management system.

3. The method of claim 1, wherein initiating the communication session between the caller and the communication management system comprises initiating a chat between the caller and the communication management system.

4. The method of claim 1, further comprising:
wherein obtaining the caller data comprises obtaining one or more statements from the caller in the communication session,
wherein the trained ML model is configured to predict intent of callers from statements provided by callers, and
wherein identifying the intent of the caller comprises processing the caller data using the trained ML model to obtain output indicating one or more candidate intents and associated one or more scores.

5. The method of claim 4, wherein the trained ML model is a trained language model comprising a trained neural network having a transformer architecture.

6. The method of claim 5,
wherein the trained ML model comprises between 100 and 500 million parameters, and
wherein processing the caller data using the trained ML model comprises calculating the output indicating the one or more candidate intents and associated one or more scores using the caller data and values of the parameters.

7. The method of claim 1,
wherein obtaining the caller data comprises obtaining data about the caller's historical behavior,
wherein the trained ML model is configured to predict intent of callers using features derived from data about callers' historical behavior,
wherein identifying the intent of the caller comprises processing the caller data using the trained ML model to obtain output indicating one or more candidate intents and associated one or more scores, and
wherein the trained ML model is a gradient boosted decision tree model that comprises between 250 and 750 decision trees.

8. The method of claim 7, wherein obtaining data about the caller's historical behavior comprises obtaining behavior features selected from the group consisting of at least 10 features selected from the features listed in Table 1.

9. The method of claim 1,
wherein the APM indicates, for each of the plurality of agents and with respect to communication sessions with callers having the same intent as the intent of the caller, a plurality of performance scores for a corresponding plurality of performance indicators,
wherein identifying the agent to assign to the caller using the identified intent of the caller and the APM, comprises:
for each particular agent of the at least some of the plurality of agents, determining a measure of performance of the particular agent using weighted combination of the plurality of performance scores of the particular agent, thereby obtaining a plurality of measures of performance, and
ranking the at least some of the plurality of agents using the plurality of measures of performance.

10. The method of claim 9, wherein the plurality of performance indicators comprise performance indicators selected from the group consisting of a customer satisfaction score, a first contact resolution indicator, a low-cost resolution indicator, an average handling time, a compliance indicator relating to lost in transit item, and a compliance indicator relating to return shipping fees.

11. The method of claim 9, further comprising:
prior to identifying the agent to assign to the caller using the identified intent of the caller and the APM,
determining weights to use when determining the measure of performance of the particular agent using the weighted combination of the plurality of performance scores of the particular agent.

12. The method of claim 9, further comprising:
prior to identifying the agent to assign to the caller using the identified intent of the caller and the APM,
determining, for each of the plurality of agents and for each of a plurality of intents, the plurality of performance scores for the corresponding plurality of performance indicators.

13. The method of claim 12,
wherein the plurality of agents includes a first agent, the plurality of intents includes a first intent, and the plurality of performance indicators includes a first performance indicator, and
wherein determining, for each of the plurality of agents and for each of a plurality of intents, the plurality of performance scores for the corresponding plurality of performance indicators comprises:
determining a first performance score for the first performance indicator of the first agent handling communication sessions with callers having the first intent at least in part by:
determining a number of communication sessions, handled by the first agent, with callers having the first intent,
when the number of communication sessions is greater than a threshold number of communication sessions with callers having the first intent, determining the first performance score based on performance indicator data about the first agent's communication sessions with callers having the first intent, and
when it is determined that the first agent has not handled the threshold number of communication sessions with callers having the first intent, determining the first performance score based on: (1) performance indicator data about the first agent's communication sessions with callers having the first intent; and (2) performance indicator data about the communication sessions between one or more other agents with callers having the first intent.

14. The method of claim 13, wherein determining the first performance score based on: (1) performance indicator data about the first agent's communication sessions with callers having the first intent; and (2) performance indicator data about the communication sessions between one or more other agents with callers having the first intent is performed using Bayesian shrinkage.

15. The method of claim 1, wherein initiating a communication session between a caller and the communication management system is performed by an interactive voice response system part of the communication management system or a virtual assistant interacting with the caller via a software application.

16. The method of claim 1, wherein:
the agent performance model comprises a set of trained machine learning (ML) models, wherein each trained ML model in the set is trained to predict, for each of the plurality of agents and with respect to communication sessions with callers having the same intent as the intent of the caller, a performance score for a corresponding performance indicator,
identifying the agent to assign to the caller using the identified intent of the caller and the APM comprises using the set of trained ML models to determine a measure of performance for each of the at least some of the plurality of agents to obtain a set of measures of performance, and
ranking the at least some of the plurality of agents using the plurality of measures of performance,
wherein the set of trained ML models comprises a gradient boosted decision tree model and/or wherein each of the ML models in the set of trained ML models is a gradient boosted decision tree model.

17. The method of claim 16, wherein using the set of trained ML models to determine a measure of performance for each of the at least some of the plurality of agents comprises:
for each particular agent of the at least some of the plurality of agents,
determining a plurality of performance scores for the particular agent using the set of trained ML models, and
determining a measure of performance for the particular agent using the plurality of performance scores.

18. The method of claim 17,
wherein the agent performance model further comprises an ensemble ML model,
wherein determining the measure of performance for the particular agent using the plurality of performance scores comprises processing the plurality of performance scores using the ensemble ML model to determine the measure of performance, and
wherein the ensemble ML model comprises a gradient boosted decision tree model.

19. A system for assigning agents to callers that have contacted a contact center by using a communication management system for the contact center, the system comprising:
at least one computer hardware processor; and
at least one non-transitory computer readable storage medium storing processor-executable instructions that, when executed by the at least one computer hardware processor, cause the at least one computer hardware processor to perform a method comprising:
initiating a communication session between a caller and the communication management system;
obtaining caller data by obtaining data from the caller in the communication session and/or obtaining data about the caller's historical behavior;
identifying an intent of the caller by using the caller data and a trained machine learning (ML) model configured to predict intent of callers;
identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and
assigning the identified agent to the caller.

20. At least one non-transitory computer readable storage medium storing processor-executable instructions that, when executed by at least one computer hardware processor, cause the at least one computer hardware processor to perform a method comprising:
initiating a communication session between a caller and the communication management system;
obtaining caller data by obtaining data from the caller in the communication session and/or obtaining data about the caller's historical behavior;
identifying an intent of the caller by using the caller data and a trained machine learning (ML) model configured to predict intent of callers;
identifying, from a plurality of agents, an agent to assign to the caller in the communication session by using the identified intent of the caller and an agent performance model (APM) configured to rank at least some of the plurality of agents based on a measure of their performance in communication sessions with callers having a same intent as the intent of the caller; and
assigning the identified agent to the caller.
